(19) United States
(12) Patent Application Publication
(10) Pub. No.: US 2025/0103688 A1
(43) Pub. Date: Mar. 27, 2025

(54) VERIFICATION OPERATIONS BASED ON WIRELESS COMMUNICATION

(71) Applicant: Capital One Services, LLC, McLean, VA (US)

(72) Inventors: Daniel Pick, Falls Church, VA (US); Jayanth Prathipati, Aldie, VA (US); Colin Hart, Falls Church, VA (US)

(73) Assignee: Capital One Services, LLC, McLean, VA (US)

(21) Appl. No.: 18/471,505

(22) Filed: Sep. 21, 2023

(51) Int. Cl. G06F 21/31; G06K 7/10

(52) U.S. Cl. CPC G06F 21/31; G06K 7/10366

(57) ABSTRACT

Verification techniques based on wireless communication with a contactless card. A passcode is generated based on a cryptogram read from a contactless card. The passcode is generated responsive to a device detecting the contactless card. The passcode has an associated account and an associated validity criterion. The passcode is stored on a server. A request specifying to perform an operation associated with the account and further specifying a passcode generated prior to the operation being specified is received. Upon a determination that the specified passcode matches the stored passcode and that the validity criterion remains satisfied, the operation specified by the request is authorized to be performed. The operation is authorized without requiring the device to redetect the contactless card

### BACKGROUND

As user devices such as mobile phones continue to increase in popularity, ensuring that access to data and private information is securely provisioned and maintained on the user devices continues to be a concern. For instance, in order to access a mobile device or an application executing on the mobile device, it is typically necessary to authenticate a user prior to providing access. However, attackers attempt to circumvent security measures by stealing passwords and eavesdropping on users during the registration and authentication processes (e.g., by conducting a man-in-the-middle attack). Thus, an attacker may attempt to intercept data, such as a public key, that can be used to infer the identity of a user, a user device, or a server computer. An attacker may also attempt to intercept authentication data such as a password or response to a challenge. The intercepted data could be used to track the user's device, or it may be used for illicit purposes. And although additional security measures can be warranted to make it harder for attackers to steal and gain access, in some cases, the additional security measures can also be overly restrictive for legitimate users, especially in certain use cases.

### BRIEF SUMMARY

Embodiments presented in this disclosure provide a method, a computer-readable medium, and a system to perform steps of verification based on wireless communication with a contactless card. The steps include storing, by a server, a passcode that is generated based on a cryptogram read from a contactless card. The passcode is generated responsive to a device detecting the contactless card. The passcode has an associated account and an associated validity criterion. The steps also include receiving one or more requests, each request specifying to perform a respective operation associated with the account. Each request further specifies a respective passcode generated prior to the operation being specified. The one or more requests are received subsequent to storing the passcode. The steps also include, upon determining that the passcode specified by a first request of the one or more requests matches the stored passcode and that the validity criterion remains satisfied, authorizing the operation specified by the first request to be performed. The operation is authorized without requiring the device to redetect the contactless card.

### BRIEF DESCRIPTION OF THE SEVERAL VIEWS OF THE DRAWINGS

FIGS. 1A-1C illustrate computing environments relating to aspects of the subject matter according to embodiments presented in this disclosure.

FIGS. 2A-2I are schematics illustrating graphical user interface (GUI) screens relating to aspects of the subject matter according to embodiments presented in this disclosure.

FIG. 3 illustrates a routine relating to verification based on wireless communication with a contactless card, according to one embodiment presented in this disclosure.

FIG. 4 illustrates another routine relating to verification based on wireless communication with a contactless card, according to one embodiment presented in this disclosure.

FIGS. 5A-5C are sequence diagrams depicting additional routines relating to verification based on wireless communication with a contactless card, according to embodiments presented in this disclosure.

FIG. 6 illustrates yet another routine relating to verification based on wireless communication with a contactless card, according to one embodiment presented in this disclosure.

FIGS. 7A-7B illustrate a contactless card according to one embodiment presented in this disclosure.

FIG. 8 illustrates a data structure according to one embodiment presented in this disclosure.

FIG. 9 illustrates a computer architecture according to one embodiment presented in this disclosure.

### DETAILED DESCRIPTION

Multi-factor authentication (MFA) can often involve a knowledge factor (what the user knows) and a possession factor (what the user has). Embodiments presented in this disclosure provide an alternative possession factor that can be characterized as “what the user recently had.” More specifically, the alternative possession factor can be characterized as “what the user preemptively asked to verify that the user has,” according to one embodiment.

At least some embodiments of the present disclosure provide passcodes that can be preemptively generated. These passcodes can be time-limited, such as to a thirty-day time window. Additionally or alternatively, these passcodes can have a maximum number of reuses permitted, such as a maximum of five uses. Advantageously, in addition to permitting the user to authorize a desired transaction by tapping a contactless card reactively, the user is permitted an additional option of tapping a contactless card preemptively to generate a time-limited and/or reusable passcode.

The preemptively generated passcode can then be used up to the maximum number of times and/or within the time window, and without requiring the user to re-tap the contactless card during those uses of the preemptively generated passcode. The user can either commit the preemptively generated passcode to memory or use the application to view the preemptively generated passcode. The user can then provide the preemptively generated passcode via a web browser or to a service agent to cause a desired operation of the user to be authorized to be performed.

The disclosed embodiments relating to preemptively generated passcodes can address a number of use cases that involve users traveling or moving overseas. In such use cases, the users may not currently be in possession of their contactless cards and/or their computing devices such as smartphones, or the smartphones may not be connected to any mobile carrier network that is compatible, in terms of communication protocols, with a network used by an institution issuing the contactless cards and/or providing accounts of the users.

Absent the disclosed embodiments relating to preemptively generated passcodes, it is conceivable that the desired operations of such users transaction cannot be authorized or performed unless the users perform additional security measures, such as providing a copy of a passport or a government identification, or undergoes a favorable change in conditions in their use cases, such as returning from travel or moving back to a previous country. With the benefit of the disclosed techniques, the desired operations of such users can be authorized and performed as long as the users recall the preemptively generated codes or can otherwise view them via the application, even if the contactless cards are not currently in the possession of these users.

To that end, disclosed embodiments also provide techniques to securely generate a passcode that may be used as a second form of authentication. Generally, a user may desire to authenticate into an account, complete a purchase, or perform any operation that requires MFA. In one example, the user may tap a contactless card toward a computing device to initiate the authentication. In response to coming into communications range with the device, the contactless card may generate a data package comprising a cryptogram and a uniform resource locator (URL). An operating system of the device may read the data package and/or the URL and launch an account application on the device that is associated with the URL. In some embodiments, if the account application is already launched but is merely inactive, the operating system may activate the account application without halting and/or re-launching the account application. In one example, the account application is associated with an issuer of the contactless card. The account application may transmit a passcode request to a passcode generator at the URL. The passcode request may include the cryptogram.

The passcode generator and/or a server associated with the passcode generator may then attempt to decrypt the cryptogram as described in greater detail herein. If the decryption is successful, the passcode generator may identify contact information for the associated account, such as a phone number, email, etc. The passcode generator may generate a passcode and transmit the passcode to the identified contact information. Depending on the embodiment, the passcode can generated preemptively or reactively relative to a time of an operation being specified by the user as being desired to be performed.

In one embodiment, the user can receive the passcode from the passcode generator and provide the received passcode as input to the account application. The account application may compare the input to an instance of the passcode received from the passcode generator. If the comparison results in a match, the account application may validate the passcode, and permit the requested operation, e.g., viewing account details, making a purchase, etc. If the comparison does not result in a match, the verification may fail, and the account application may reject or otherwise restrict performance of the requested operation. It is contemplated that at a given point in time, multiple passcodes, including passcodes of different types, such as preemptively versus reactively generated passcodes, can be acceptable for causing a desired operation to be authorized to be performed.

Accordingly, disclosed embodiments also provide secure techniques for generating a passcode for MFA using a contactless card. Using cryptograms generated by contactless cards, disclosed embodiments can securely verify the identity of the user requesting to perform a desired operation, with minimal risk of fraudulent activity. Furthermore, doing so ensures that passcodes are only generated when the user has access to a contactless card as well as a computing device with a secure application for facilitating the cryptogram verification with the server. Furthermore, by providing a simplified passcode-generation process, more requests may be handled by the server, thereby improving system performance.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

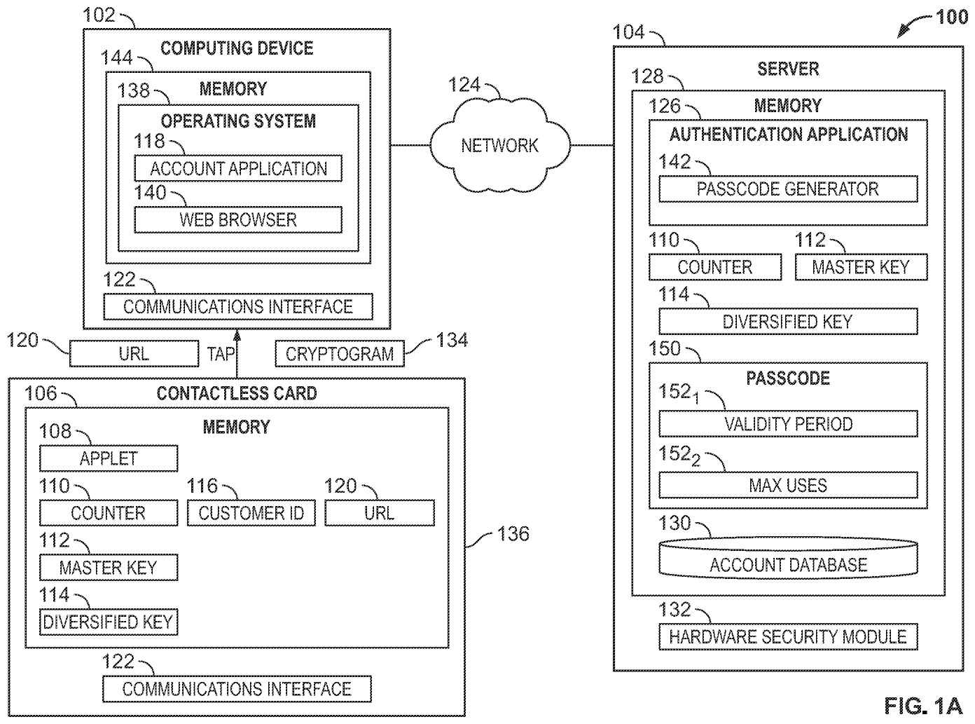

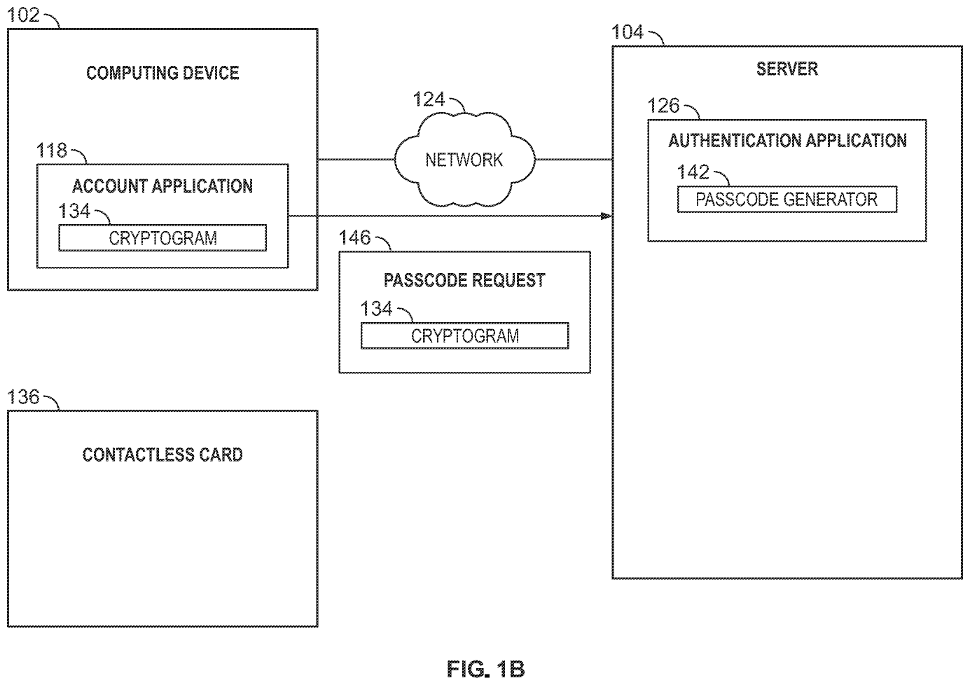

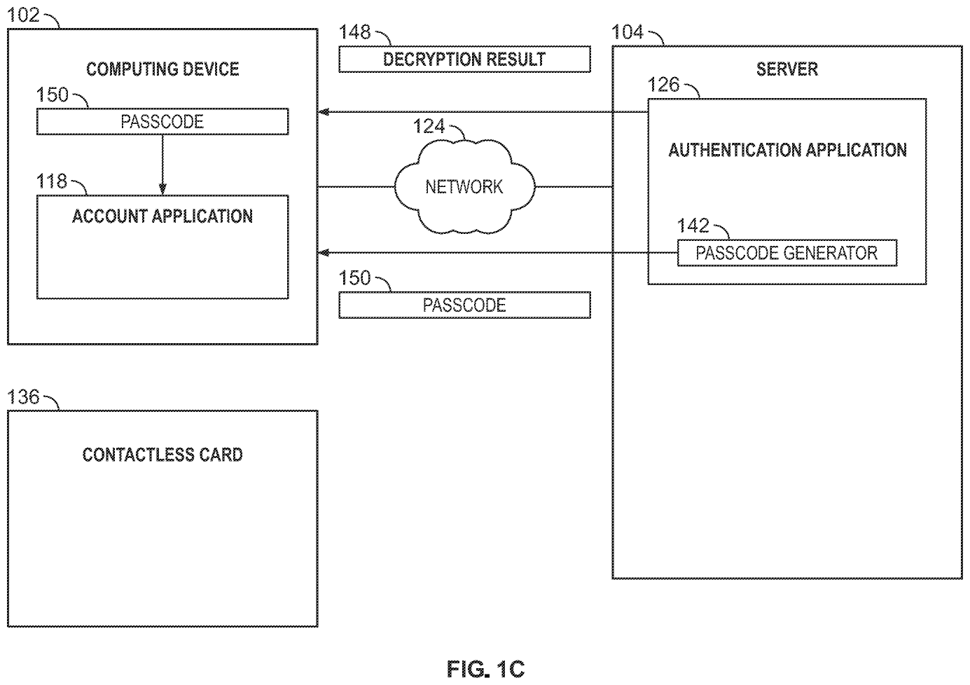

FIG. 1A depicts an exemplary computing architecture 100, also referred to as a system, consistent with disclosed embodiments. Although the computing architecture 100 shown in FIGS. 1A-1C has a limited number of elements in a certain topology, it may be appreciated that the computing architecture 100 may include more or less elements in alternate topologies as desired for a given implementation.

The computing architecture 100 comprises a computing device 102, a server 104, and a contactless card 136. The contactless card 136 is representative of any type of payment card, such as a credit card, debit card, ATM card, gift card, and the like. The contactless card 136 may comprise one or more communications interfaces 122, such as a radio frequency identification (RFID) chip, configured to communicate with a communications interface 122 (also referred to herein as a “card reader”, a “wireless card reader”, and/or a “wireless communications interface”) of the computing devices 102 via NFC, the EMV standard, or other short-range protocols in wireless communication. Although NFC is used as an example communications protocol herein, the disclosure is equally applicable to other types of wireless communications, such as the EMV standard, Bluetooth, and/or Wi-Fi.

The computing device 102 is representative of any number and type of computing device, such as smartphones, tablet computers, wearable devices, laptops, portable gaming devices, virtualized computing system, merchant terminals, point-of-sale systems, servers, desktop computers, and the like. A mobile device is used as an example of the computing device 102, but should not be considered limiting of the disclosure. The server 104 is representative of any type of computing device, such as a server, workstation, compute cluster, cloud computing platform, virtualized computing system, and the like. Although not depicted for the sake of clarity, the computing device 102, contactless card 136, and server 104 each include one or more processor circuits to execute programs, code, and/or instructions.

As shown, a memory 106 of the contactless card 136 includes an applet 108, a counter 110, a master key 112, a diversified key 114, and a unique customer identifier (ID) 116. The applet 108 is executable code configured to perform the operations described herein. The counter 110, master key 112, diversified key 114, and customer ID 116 are used to provide security in the system 100 via a passcode 150 and as described in greater detail below.

As shown, a memory 144 of the mobile device 102 includes an instance of an operating system (OS) 138. Example operating systems 138 include the Android® OS, iOS®, macOS®, Linux®, and Windows® operating systems. As shown, the OS 138 includes an account application 118 and a web browser 140. The account application 118 allows users to perform various account-related operations, such as activating payment cards, viewing account balances, purchasing items, processing payments, and the like. In some embodiments, a user may authenticate using authentication credentials to access certain features of the account application 118. For example, the authentication credentials may include a username (or login) and password, biometric credentials (e.g., fingerprints, Face ID, etc.), and the like. The web browser 140 is an application that allows the device 102 to access information via the network 124 (e.g., via the Internet).

As shown, a memory 128 of the server 104 includes an authentication application 123, which includes a passcode generator 142. Although depicted as integrated components of the server 104, in some embodiments, the authentication application 123 and the passcode generator 142 may be separated into distinct components. Furthermore, the authentication application 123 and/or the passcode generator 142 may be implemented in hardware, software, and/or a combination of hardware and software.

In some embodiments, to secure the account application 118 and/or associated data, e.g., details of the user's account in the account database 130, the system 100 may provide for secure generation of passcodes using the contactless card 136. For example, a user may provide authentication credentials to the account application 118, such as a username/password that are validated by the account application 118 (e.g., using a local instance of the account database 130 and/or transmitting the credentials to the server 104 for validation). Once validated, the account application 118 may instruct the user to tap the contactless card 136 to the computing device 102.

In the embodiment depicted in FIG. 1A, the user may tap the contactless card 136 to the computing device 102 (or otherwise bring the contactless card 136 within communications range of the card reader of the device 102). The applet 108 of the contactless card 136 may then generate a URL 120 that is directed to a resource, such as the server 104, the authentication application 126, and/or the passcode generator 142. In some embodiments, the applet 108 constructs the URL 120 according to one or more rules. In some embodiments, the contactless card 136 stores a plurality of URLs 120 and the applet 108 selects the URL 120 from the plurality of URLs 120 based on one or more rules. In some embodiments, the applet 108 may generate the URL 120 by selecting a URLs 120 and adding dynamic data, such as a cryptogram 134, as one or more parameters of the URL.

The cryptogram 134 may be based on the customer ID 116 of the contactless card 136. The cryptogram 134 may be generated based on any suitable cryptographic technique. In some embodiments, the applet 108 may include the URL 120, the cryptogram 134, and an unencrypted identifier (e.g., the customer ID 116, an identifier of the contactless card 136, and/or any other unique identifier) as part of a data package. In at least one embodiment, the data package is an NDEF file.

As stated, the computing architecture 100 is configured to implement key diversification to secure data, which may be referred to as a key diversification technique herein. Generally, the server 104 (or another computing device) and the contactless card 136 may be provisioned with the same master key 112 (also referred to as a master symmetric key). More specifically, each contactless card 136 is programmed with a distinct master key 112 that has a corresponding pair in the server 104. For example, when a contactless card 136 is manufactured, a unique master key 112 may be programmed into the memory 106 of the contactless card 136. Similarly, the unique master key 112 may be stored in a record of a customer associated with the contactless card 136 in the account database 130 of the server 104 (and/or stored in a different secure location, such as the hardware security module (HSM) 132). The master key 112 may be kept secret from all parties other than the contactless card 136 and server 104, thereby enhancing security of the system 100. In some embodiments, the applet 108 of the contactless card 136 may encrypt and/or decrypt data (e.g., the customer ID 116) using the master key 112 and the data as input a cryptographic algorithm. For example, encrypting the customer ID 116 with the master key 112 may result in the cryptogram 134. Similarly, the server 104 may encrypt and/or decrypt data associated with the contactless card 136 using the corresponding master key 112.

In other embodiments, the master keys 112 of the contactless card 136 and server 104 may be used in conjunction with the counters 110 to enhance security using key diversification. The counters 110 comprise values that are synchronized between the contactless card 136 and server 104. The counter 110 may comprise a number that changes each time data is exchanged between the contactless card 136 and the server 104 (and/or the contactless card 136 and the computing device 102). When preparing to send data (e.g., to the server 104 and/or the device 102), the applet 108 of the contactless card 136 may increment the counter 110. The applet 108 of the contactless card 136 may then provide the master key 112 and counter 110 as input to a cryptographic algorithm, which produces a diversified key 114 as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm such as 3DES or AES107; a symmetric HMAC algorithm, such as HMAC-SHA-256; and a symmetric CMAC algorithm such as AES-CMAC. Examples of key diversification techniques are described in greater detail in U.S. patent application Ser. No. 16/205,119, filed Nov. 29, 2018. The aforementioned patent application is incorporated by reference herein in its entirety.

Continuing with the key diversification example, the applet 108 may then encrypt the data (e.g., the customer ID 116 and/or any other data) using the diversified key 114 and the data as input to the cryptographic algorithm. For example, encrypting the customer ID 116 with the diversified key 114 may result in an encrypted customer ID (e.g., a cryptogram 134). In some embodiments, the cryptogram 134 is included in as a parameter of the URL 120. In other embodiments, the cryptogram 134 is not a parameter of the URL 120, but is transmitted with the URL 120 in a data package such as an NDEF file. The operating system 138 may then read the data package including the URL 120 and cryptogram 134 via the communications interface 122 of the computing device 102.

As stated, the cryptogram 134 may be a parameter of the URL 120. For example, the URL 120 may be “http://www.example.com/passcodegenerator?param=ABC123”. In such an example, the cryptogram 134 may correspond to the parameter “ABC123”. However, if the cryptogram 134 is not a parameter of the URL 120, the URL 120 may be “http://www.exmaple.com/passcodegenerator.” Regardless of whether the URL 120 includes the cryptogram 134 as a parameter, the URL 120 may be registered with the account application 118, which causes the operating system 138 to launch the account application 118, and provide the URL 120 and cryptogram 134 to the account application 118 as input.

The account application 118 may then transmit the cryptogram 134 to the server 104 with a request to generate a passcode. In embodiments where the URL 120 includes the cryptogram 134 as a parameter, the account application 118 extracts the cryptogram 134 from the URL 120 and transmits the request with cryptogram 134 to an address associated with the passcode generator 142, e.g., at least a portion of the URL 120. In some embodiments, the 118 makes an application programming interface (API) call to the passcode generator 142. Further still, the account application 118 may include another identifier, such as the unencrypted customer ID 116 provided by the applet 108 in the data package. In some embodiments, the other identifier may be an identifier of the contactless card 136, an account identifier, and the like. In such embodiments, the account application 118 may include an instance of one or more portions of the account database 130 to determine the other identifier.

In one embodiment, the passcode 150 can be either a remedial passcode or a preemptive passcode. A remedial passcode refers to a passcode that is generated responsive to prompting after a desired transaction has been specified by the user. An example of a remedial passcode is a one-time passcode (OTP). The OTP can be a time-based OTP (TOTP) or a hash-based OTP (HOTP). In contrast to a remedial passcode, a preemptive passcode refers to a passcode that that is generated prior to any such desired transaction having been specified by the user. Such a passcode is thus generated preemptively in relation to any such desired transaction being specified. The preemptive passcode can subsequently be used to authorize one or more desired transaction that the user was not required to have specified when the preemptive passcode was generated. Indeed, the user when the preemptive passcode was generated may not even be aware that those transactions would later be desired on the part of the user.

As used herein, a preemptive passcode is also referred to as a standalone passcode, while a remedial passcode is also referred to as a reliant or non-standalone passcode. The “standalone” nomenclature is intended to signify that the preemptive passcode can be used at a subsequent point in time and without requiring physical possession of the contactless card at that point in time.

For instance, if the user requests to perform a transaction that requires MFA, the user can be prompted to provide a passcode to authorize the transaction. In some embodiments, the prompting of the user includes instructions for the user to tap the contactless card to the computing device to cause a remedial passcode to be generated by the passcode generator. The user can then provide the remedial passcode to the account application, which confirms whether the remedial passcode provided by the user matches a remedial passcode received from the passcode generator. If there is a match, the account application authorizes the transaction to be performed.

The passcode to authorize the transaction can be remedial or preemptive, however. Suppose that when the user is prompted to provide the passcode in the earlier example, the user is not currently in possession of the contactless card or cannot be notified of the remedial passcode once it is generated. Such can often be the case when the user is traveling. For instance, the user may have left the contactless card at home. Additionally or alternatively, the current mobile carrier network of the computing device of the user is incapable of communications with the server and its associated systems.

Still other users having computing devices incapable of running the application or simply choose not to run the application on the computing devices. Examples of such computing devices include mobile devices that constitute smartphones, mobile devices that do not constitute smartphones, such as laptops or flip phones, and non-mobile devices such as a personal computer. Such users may resort to accessing a web application of the institution in lieu of running the application.

In some embodiments, the web application may provide only a subset of a full range of features provided by the web application. For instance, it is conceivable that the web application may not provide a feature of recognizing the contactless card via tapping, even though the application can provide a feature of retrieving and viewing a preemptive passcode previously generated for the user (e.g., via a different computing device of the user). In other embodiments, however, the web application may nevertheless provide the feature of recognizing the contactless card via tapping, provided that the web application ascertains that the computing device of the user includes or is operatively connected to a Near-Field Communication (NFC) device coupled with an antenna capable of communicating via the NFC protocol, as an example.

As a result, regardless of the specific use-case involved, the computing device of the user can be incapable of receiving, for instance, Short Message Service (SMS) messages from computing systems associated with a given institution. In one embodiment, the inability of the computing device to receive SMS messages can be a consequence of differences in networking protocols such as Code-Division Multiple Access (CDMA) and Global System for Mobile Communication (GSM). The given institution can be a financial institution that, at least in part, provides and/or maintains a banking system that includes the account of the user. Additionally or alternatively, the given institution can also issue the contactless card and/or provide and maintain the account application and/or the server.

In one embodiment, the passcode generation techniques described herein are partially or fully applicable to generate passcodes regardless of whether the passcodes are remedial passcodes or preemptive passcodes. At least in one embodiment, remedial passcodes and preemptive passcodes differ from one another only in terms of a set of passcode attributes. In a particular embodiment, for instance, remedial passcodes are valid for no more than a single use within five minutes, whereas preemptive passcodes are valid for any number of uses within thirty days. The figures of five minutes and thirty days are given only as examples and are not limiting of the scope of disclosed embodiments. Depending on the embodiment, remedial passcodes can be valid for a duration that is shorter or longer than five minutes. Additionally or alternatively, preemptive passcodes can be valid for a duration that is shorter or longer than thirty days.

In some embodiments, regardless of whether the passcode 150 is a remedial passcode or a preemptive passcode, the passcode 150 can be associated with one or more validity criteria 152. In such embodiments, the one or more validity criteria 152 need to be satisfied for the passcode 150 to be deemed valid. As shown, the one or more validity criteria 152 include, without limitation, a validity period 152₁ and a maximum number of uses 152₂. The validity period 152₁ specifies a period of time in which the passcode 150 is deemed valid.

Depending on the embodiment, the validity period 152₁ can be represented in the form of an expiry date and/or time (e.g., Jun. 15, 2023 at 12:00:00 am) or in the form of a given length of time (e.g., 30 days). If the period of time has elapsed, the passcode 150 is no longer valid. In an alternative embodiment, the passcode 150 does not have any associated validity period. In such an embodiment, the passcode 150 either is not associated with any validity period or is associated with a particular value (e.g., null) arbitrarily predefined to represent that a validity period does not apply. If the passcode 150 is not associated with any validity period, the passcode 150 is valid provided that the maximum number of uses 152₂ has not yet been met.

The maximum number of uses 152₂ specifies a number of times the passcode 150 can be used at maximum. The passcode 150 remains valid provided that a current number of uses of the passcode 150 has not yet reached the maximum number of uses 152₂. In an alternative embodiment, the passcode 150 does not have any maximum number of uses. In such an embodiment, the passcode 150 either is not associated with any maximum number of uses or is associated with a particular maximum number (e.g., −1) arbitrarily predefined to represent unlimited usage. If the passcode 150 is not associated with any maximum number of uses, the passcode 150 is valid provided that the validity period 152₁ has not yet elapsed.

In one embodiment, the maximum number of uses 152₂ specifies a single use as being the maximum. If the passcode 150 is a preemptive passcode, the passcode 150 can be referred to as a non-reusable preemptive passcode to avoid confusion with an OTP, which, unlike the non-reusable preemptive passcode, is generated reactively rather than preemptively.

Additionally or alternatively, the maximum number of uses 152₂ can specify a number greater than one as being the maximum (e.g., five uses), according to one embodiment. Such a passcode can be a same passcode that is usable to authorize multiple, different operations to be performed. If such a passcode is a preemptive passcode, the passcode can be referred to as a reusable preemptive passcode. The maximum number of uses can be tailored to suit the needs of a particular case.

In some embodiments, the validity period 152₁ and/or the maximum number of uses 152₂ can be determined based on criteria set by the institution and/or based on input from the user. In alternative embodiments, determination of the validity period 152₁ and/or of the maximum number of uses 152₂ is not based on any input from the user but is determined based solely on the criteria set by the institution.

FIG. 1B depicts an embodiment where the account application 118 transmits a passcode request 146 comprising the cryptogram 134 and the unencrypted identifier to the server 104. Once received, the server 104 may attempt to authenticate the cryptogram 134. For example, the authentication application 126 may attempt to decrypt the cryptogram 134 using a copy of the master key 112 stored by the server 104. In some embodiments, the authentication application 126 may identify the master key 112 and counter 110 using the unencrypted customer ID 116 (or other identifier) provided by the account application 118 to the server 104. In some examples, the authentication application 126 may provide the master key 112 and counter 110 as input to the cryptographic algorithm, which produces a diversified key 114 as output. The resulting diversified key 114 may correspond to the diversified key 114 of the contactless card 136, which may be used to decrypt the cryptogram 134.

Regardless of the decryption technique used, the authentication application 126 may successfully decrypt the cryptogram 134, thereby verifying or authenticating the cryptogram 134 in the passcode request 146 (e.g., by comparing the customer ID 116 that is produced by decrypting the cryptogram 134 to a known customer ID stored in the account database 130, and/or based on an indication that the decryption using the master key 112 and/or diversified key 114 was successful). Although the keys 112, 114 are depicted as being stored in the memory 128, the keys may be stored elsewhere, such as in a secure element and/or the HSM 132. In such embodiments, the secure element and/or the HSM 132 may decrypt the cryptogram 134 using the master key 112 and/or diversified key 114 and a cryptographic function. Similarly, the secure element and/or HSM 132 may generate the diversified key 114 based on the master key 112 and counter 110 as described above. If the decryption is successful, the authentication application 126 may identify contact information for the user, e.g., an email address, phone number, a device identifier registered to the instance of the account application 118, a device identifier of the computing device 102, etc., stored in the account database 130. The authentication application 126 may identify the contact information based on the unencrypted identifier included in the passcode request 146. The authentication application 126 may then instruct the passcode generator 142 to generate a passcode and transmit the passcode to the identified contact information.

If, however, the authentication application 126 is unable to decrypt the cryptogram 134 to yield the expected result (e.g., the customer ID 116 of the account associated with the contactless card 136), the authentication application 126 does not validate the cryptogram 134. In such an example, the authentication application 126 determines to refrain from generating a passcode. The authentication application 126 may transmit an indication of the failed decryption to the account application 118.

FIG. 1C depicts an embodiment where the authentication application 126 transmits a decryption result 148 to the account application 118. The decryption result 148 generally indicates whether the server 104 decrypted the cryptogram 134 or did not decrypt the cryptogram 134. In the example depicted in FIG. 1C, the decryption result 148 indicates that the server 104 decrypted the cryptogram 134. The account application 118 may use the decryption result 148 to determine whether the cryptogram 134 was decrypted. Based on the successful decryption, the passcode generator 142 may generate and transmit a passcode 150 to the computing device 102 based on the determined contact information. The passcode 150 may be any alphanumeric string of any length. If the contact information is a phone number, the passcode generator 142 may transmit the passcode 150 via a short message service (SMS) message. If the contact information is an email address, the passcode generator 142 may transmit the passcode 150 via email. If the contact information is a device identifier, the passcode generator 142 may transmit the passcode 150 as part of a push notification directed to the computing device 102.

The user may then provide the received passcode as input to the account application 118 via a user interface. The account application 118 may then compare the input provided by the user to an instance of the passcode 150 received from the passcode generator 142. In another embodiment, the account application 118 may transmit the user input to the passcode generator 142, which performs the comparison. If the passcode generator 142 performs the comparison, the passcode generator 142 transmits a comparison result to the account application 118. In some embodiments, the user may provide the input to another application, such as the web browser 140 that has loaded a page associated with the passcode generator 142. The web page may then perform the comparison. If the comparison results in a match, the multi-factor authentication may be completed, and the user may be able to perform one or more requested operations. For example, the user may view account attributes, perform an operation associated with the account, make a payment, transfer funds, view balances, etc.

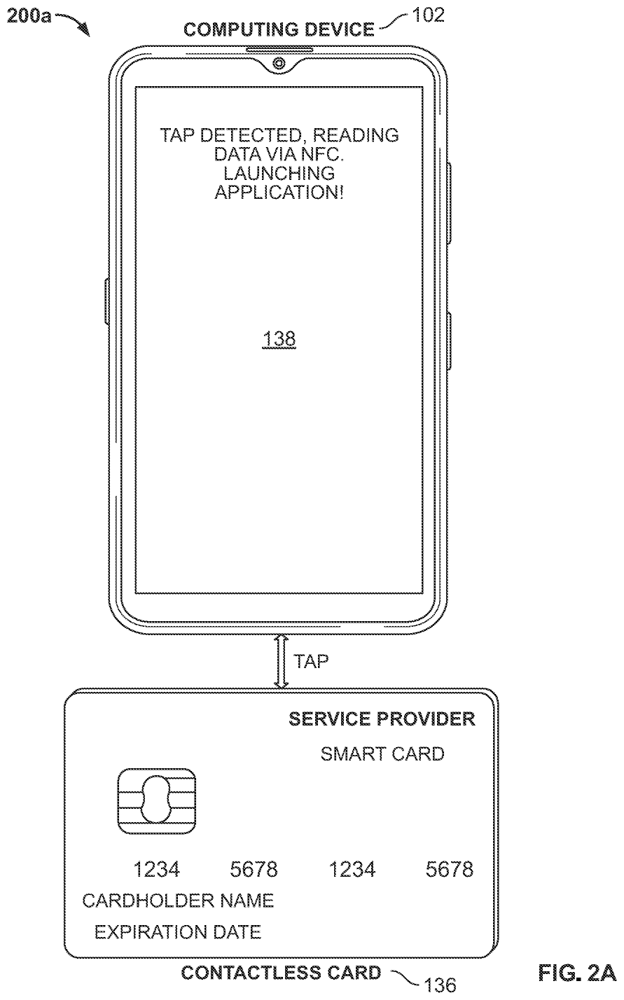

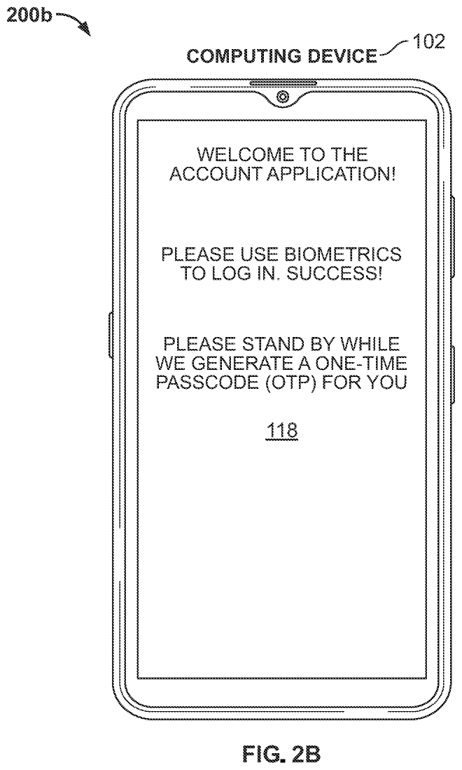

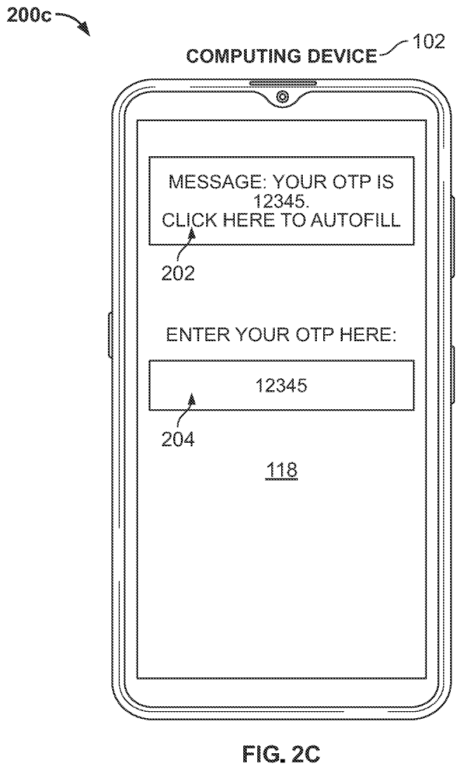

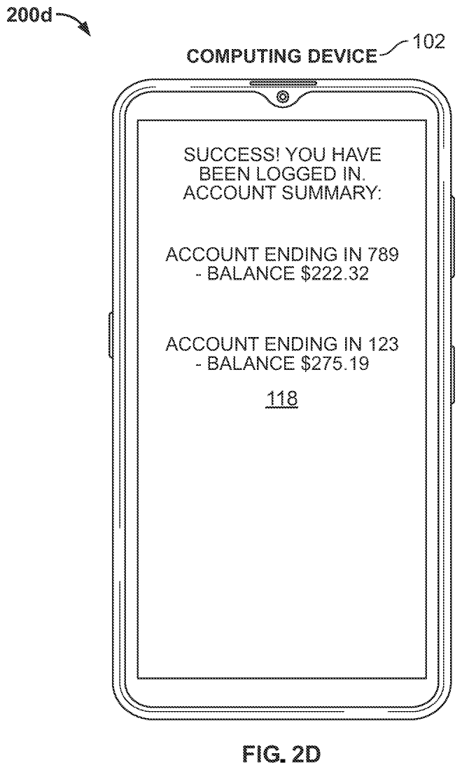

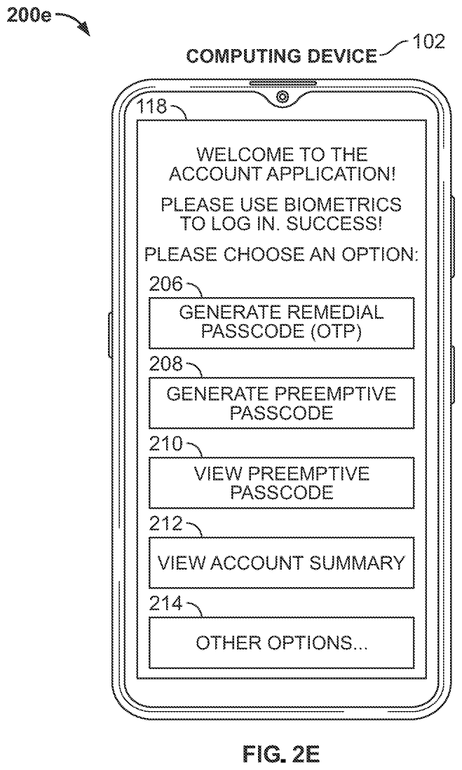

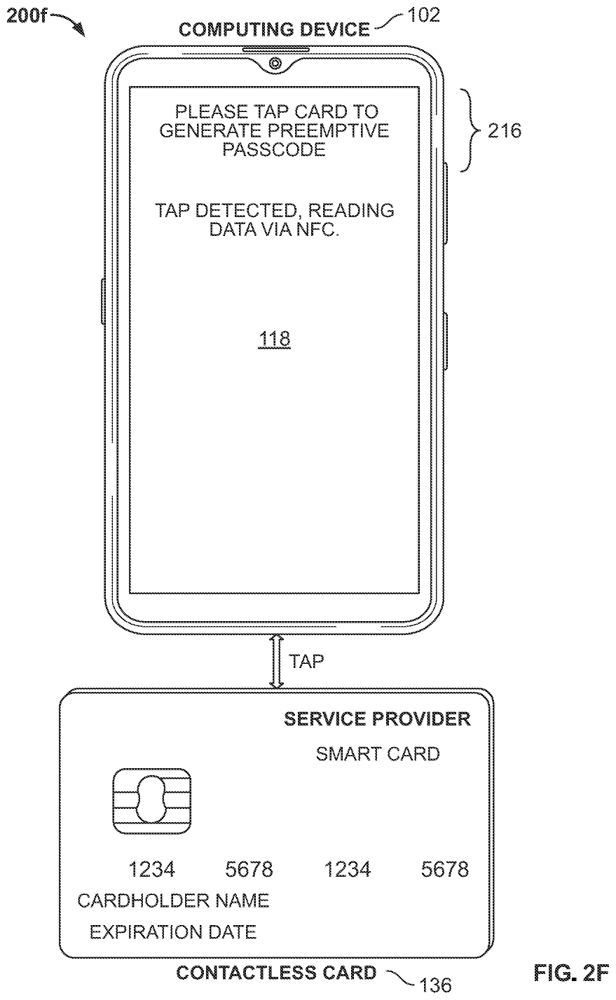

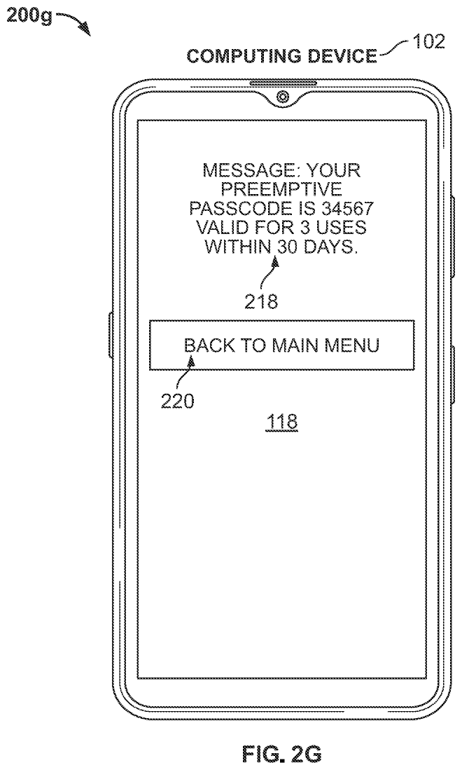

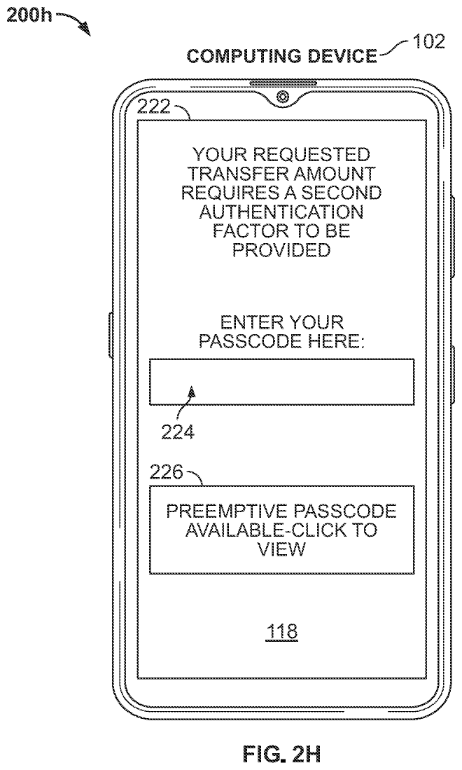

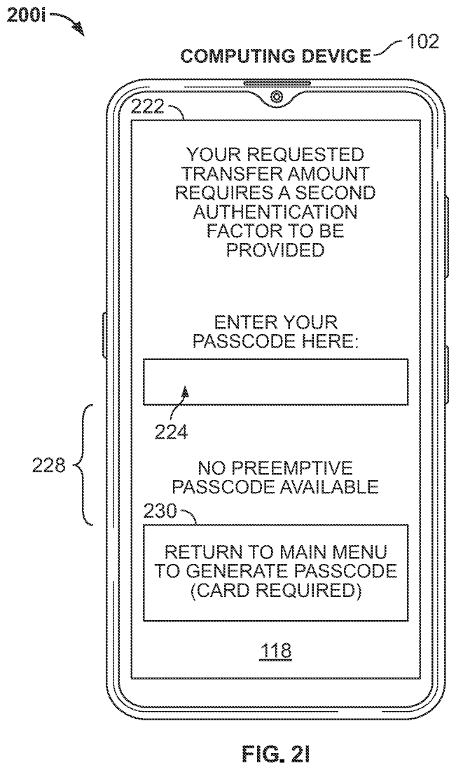

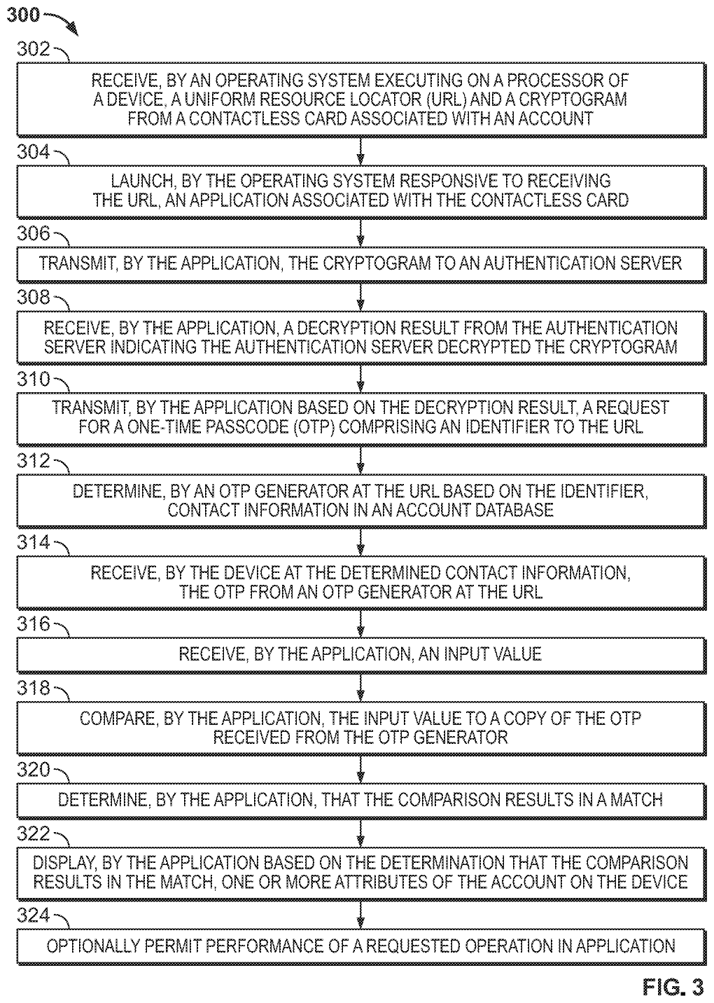

FIGS. 2A-2I are schematics illustrating graphical user interface (GUI) screens relating to aspects of the subject matter according to some embodiments. Referring to FIG. 2A, a schematic 200a is shown to illustrate an embodiment where a contactless card 136 is tapped to a computing device 102. While the computing device 102 is depicted as outputting a screen (e.g., a home screen) of the operating system 138, the computing device 102 may generally be in any state. For example, the user may be using another application, such as the web browser 140, when tapping the contactless card 136 to the computing device 102.

As stated, when the contactless card 136 is tapped to the computing device 102, the applet 108 may generate a cryptogram 134 and URL 120. In some embodiments, the cryptogram 134 is a parameter of the URL 120. The applet 108 may further include an identifier, such as an unencrypted customer ID 116, an identifier of the contactless card 136, and the like. If the cryptogram 134 is a parameter of the URL 120, the unencrypted identifier may also be a parameter of the URL 120. Regardless of whether the cryptogram 134 and/or unencrypted identifier are parameters of the URL 120, the cryptogram 134, unencrypted identifier, and the URL 120 may be included in a data package, such as an NDEF file, that is read by the computing device 102. As shown, responsive to receiving the data package, the operating system 138 may launch the account application 118, as the URL 120 (or a portion thereof) may be registered with the account application 118 in the operating system 138.

FIG. 2B is a schematic 200b illustrating an embodiment where the account application 118 is opened responsive to the operating system 138 reading the URL 120 received from the contactless card 136. As shown, the account application 118 instructs the user to provide a first authentication factor, which may be biometric credentials. The account application 118 may verify the biometric credentials, and based on the verification, generate a passcode request 146 for a passcode 150 from the passcode generator 142. In one embodiment, the passcode 150 can be a remedial passcode such as an OTP. As stated, the account application 118 may transmit the cryptogram 134 and an unencrypted identifier to the passcode generator 142. In some embodiments, the passcode request 146 may be an API call.

The authentication application 126 may then attempt to decrypt the cryptogram 134 as described in greater detail above. If the decryption is successful, the authentication application 126 may identify contact information for the user's account in the account database 130. In some embodiments, the contact information is identified based on the unencrypted identifier, e.g., the unencrypted customer ID 116, a device ID, and the like. The authentication application 126 may then instruct the passcode generator 142 to generate a passcode 150 and transmit the passcode 150 to the contact information. The authentication application 126 may also transmit a decryption result 148 to the account application 118.

FIG. 2C is a schematic 200c illustrating an embodiment where the passcode 150 is sent to the computing device 102 as a push notification 202. The user may be instructed to enter the passcode 150 in the input field 204. As stated previously, the passcode 150 can be a remedial passcode such as an OTP. As shown, the push notification 202 allows the user to select the push notification 202 to autofill the passcode 150 to the field 204. For example, when selected, an autofill service (not pictured) of the operating system 138 may copy the passcode 150 and fill the passcode 150 into the field 204. In another example, the passcode 150 may be copied to a clipboard (not pictured) of the operating system 138. Doing so allows the user to paste the passcode 150 from the clipboard to the field 204.

As shown, the passcode 150 may be entered as input to field 204. The account application 118 may then verify the passcode 150 entered into field 204, e.g., by comparing the input to an instance of the passcode 150 received from the passcode generator 142. In another example, the account application 118 provides the input entered into field 204 to the passcode generator 142, which performs the comparison, and returns a result of the comparison to the account application 118. If the comparison results in a match, the account application 118 may determine the multi-factor authentication is complete.

FIG. 2D is a schematic 200d illustrating an embodiment where the input provided in field 204 matches the passcode 150. Based on the match and the decryption of the cryptogram 134, the user may be logged into their account in the account application 118. As shown, the account application 118 displays various account attributes, e.g., account balances. Embodiments are not limited in this context, as the MFA using the passcode 150 may be used to authorize any requested operation.

FIG. 2E is a schematic 200e illustrating an embodiment that provides the user of the computing device 102 with options relating to different passcode types including remedial passcodes and preemptive passcodes. In some embodiments, the options constitute a menu of the account application. Further, the menu can be a main menu of the account application. As shown, the computing device 102 presents the user with options that include a first option 206 to generate a remedial passcode and a second option 208 to generate a preemptive passcode.

The options also include a third option 210 to view a preemptive passcode that has been generated. In some embodiments, the third option 210 is omitted from display or is displayed as being unselectable, if no valid, generated preemptive passcode remains. The options also include a fourth option 212 to view a summary of the account of the user and a fifth option 214 to access additional options relating to the account of the user. These additional options can include requesting desired operations to be performed, such as initiating a transfer of a desired amount, making a bill payment, and the like.

If the computing device 102 receives user input activating the first option 206 to generate a remedial passcode, the schematics 200a, 200b of FIGS. 2A-2B can apply. If the computing device 102 receives user input activating the second option 208 to generate a preemptive passcode, a schematic 200f of FIG. 2F can apply. If the computing device 102 receives user input activating the third option 210 to view a preemptive passcode that has been generated, a schematic 200g of FIG. 2G can apply.

If the computing device 102 receives user input activating the fifth option 214 to access additional options and receives further input specifying a desired transaction that necessitates a second authentication factor to be provided by the user, a schematic 200h of Figure H can apply if a preemptive passcode has previously been generated and is valid, whereas a schematic 200i of Figure I can apply if no valid, generated preemptive passcode is found.

FIG. 2F is a schematic 200f illustrating an embodiment in which the user has requested to generate a preemptive passcode. As shown, the schematic 200f includes a notification 216 instructing the user to tap the contactless card 136 toward the computing device 102 to generate a preemptive passcode. After the contactless card 136 is tapped, the schematic 200g of FIG. 2G can apply.

FIG. 2G is a schematic 200g illustrating an embodiment in which the user has tapped the contactless card 136 toward the computing device 102 to generate a preemptive passcode. As shown, the schematic 200g includes a notification 218 informing the user of the preemptive passcode that has been generated. The notification 218 can specify a validity period, if any, for the preemptive passcode and/or a maximum number of uses, if any, for the preemptive passcode. The schematic 200g also includes an option 220 for returning to the main menu, such as the one included in the schematic 200e of FIG. 2E.

FIG. 2H is a schematic 200h illustrating an embodiment in which the user is prompted to provide a second authentication factor so that a desired transaction can be authorized, where the user has previously requested to generate a preemptive passcode. As shown, the schematic 200h includes a notification 222 that the operation specified by the user as being desired warrants a second authentication factor to be provided by the user. The schematic 200h also includes an input field 224 in which the user is prompted to input a passcode, such as a remedial passcode or a preemptive passcode, to authorize the desired operation. The schematic 200h further includes an option 226 to view a previously generated preemptive passcode that remains valid. As shown, the option 226 also notifies the user that such a preemptive passcode is indeed available for viewing.

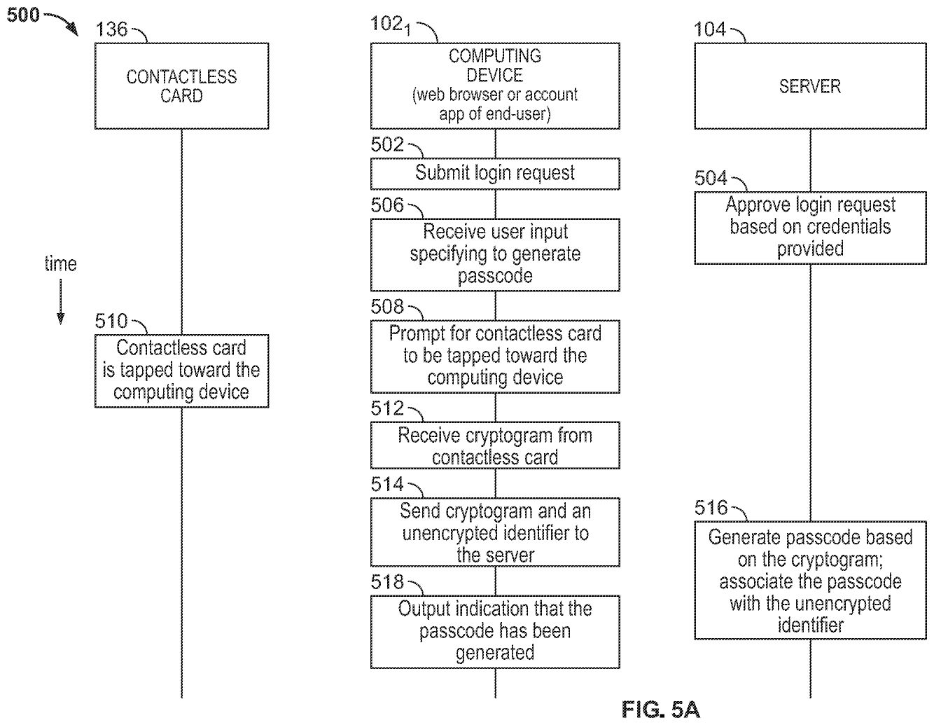

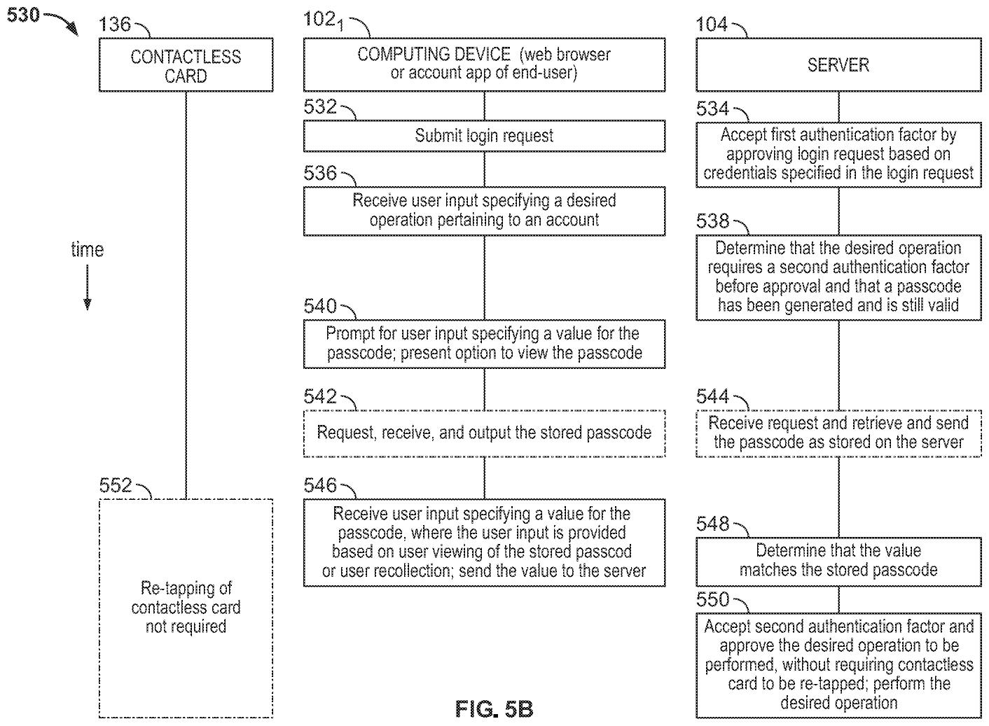

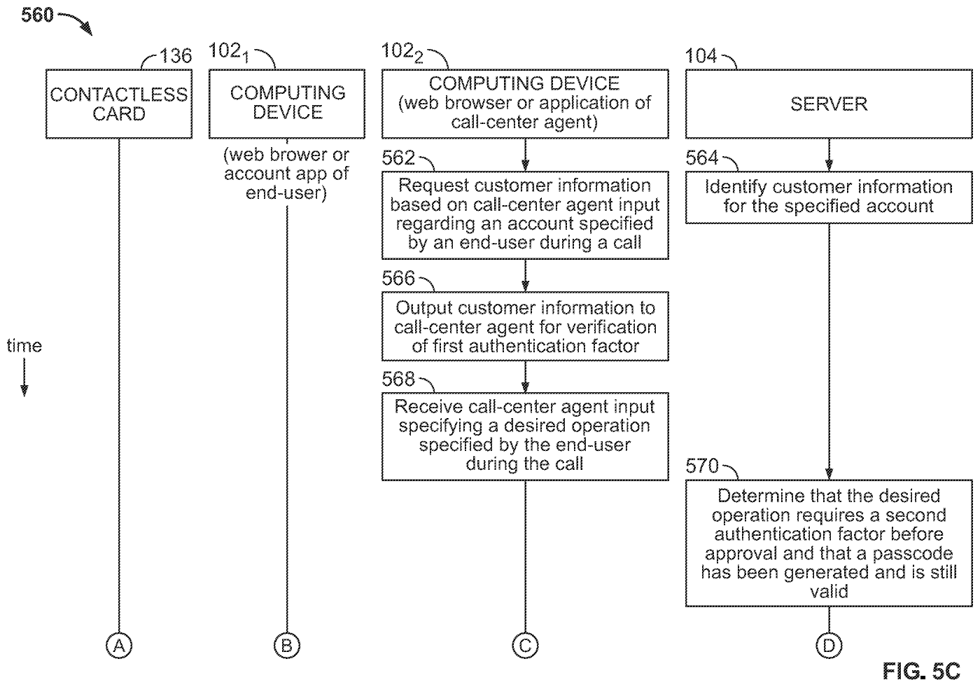

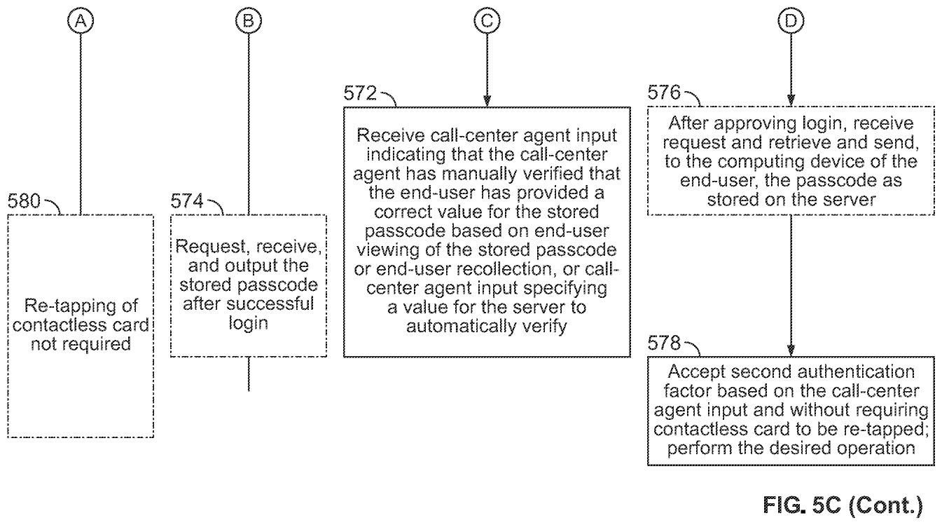

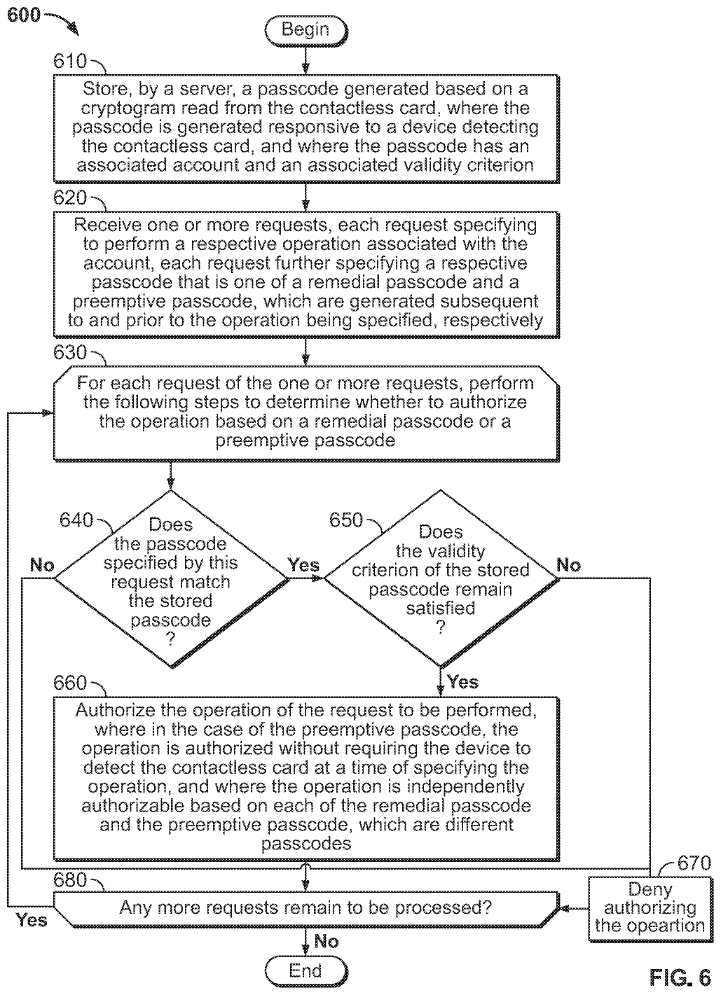

FIG. 2I is a schematic 200i illustrating an embodiment in which the user is prompted to provide a second authentication factor so that a desired transaction can be authorized, where the user has not previously requested to generate a preemptive passcode. The schematic 200i includes a notification 228 that no preemptive passcode is available for viewing. The schematic 200i further includes an option 230 to return to the main menu, such as the one included in the schematic 200e of FIG. 2E. As shown, the option 230 also notifies the user that the contactless card is required to generate a remedial passcode or a preemptive passcode. Aspects relating to generating and using a remedial passcode are further described in conjunction with sequence diagrams of FIGS. 5A-5C and a flow diagram of FIG. 6.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

FIG. 3 illustrates an embodiment of a logic flow, or routine, 300. The routine 300 may be representative of some or all of the operations executed by one or more embodiments described herein. For example, the routine 300 may include some or all of the operations to enable secure generation of a passcode using a contactless card. Embodiments are not limited in this context. Although the passcode is specifically depicted in the routine 300 as being an OTP, such a depiction is for illustrative purposes only. Depending on the embodiment, some or all of the operations of the routine 300 can apply to generate both remedial passcodes and preemptive passcodes.

In block 302, the routine 300 receives, by an operating system 138 executing on a processor of a computing device 102, a uniform resource locator (URL) 120 and a cryptogram 134 from a contactless card 136 associated with an account. In block 304, routine 300 launches, by the operating system 138 responsive to receiving the URL 120, the account application 118 associated with the contactless card 136. In some embodiments, however, the account application 118 is executing in the foreground of the operating system 138 and need not be launched. In such embodiments, the user may request to perform an operation, such as viewing an account balance, transferring funds, etc.

In block 306, the routine 300 transmits, by the account application 118, the cryptogram 134 to an authentication server, such as the server 104 in one embodiment. The account application 118 may further include an unencrypted identifier, e.g., the customer ID 116 and/or a device identifier to the authentication application 126. In block 308, the routine 300 receives, by the account application 118, a decryption result 148 from the server 104 indicating the authentication server decrypted the cryptogram 134.

In block 310, the routine 300 transmits, by the account application 118 based on the decryption result, a request for a passcode comprising an identifier to the server 104. The identifier may be the unencrypted customer ID 116, the device identifier, and/or an identifier of the contactless card 136. In block 312, the routine 300 determines, by the server 104 based on the identifier, contact information in an account database 130. The contact information may include, but is not limited to, a phone number, email address, device identifier, etc. In block 314, the routine 300 receives, by the computing device 102 at the determined contact information, the passcode 150 from the passcode generator 142. In block 316, the routine 300 receives, by the account application 118, an input value from the user.

In block 318, the routine 300 compares, by the account application 118, the input value to a copy of the passcode received from the passcode generator 142. In block 320, routine 300 determines, by the account application 118, that the comparison results in a match. In block 322, the routine 300 displays, by the account application 118 based on the decryption result 148 and the determination that the comparison results in the match, one or more attributes of the account on the device. Additionally and/or alternatively, the account application 118 may authorize performance of an operation requested by the user based on the determination that the comparison results in a match and the decryption result 148.

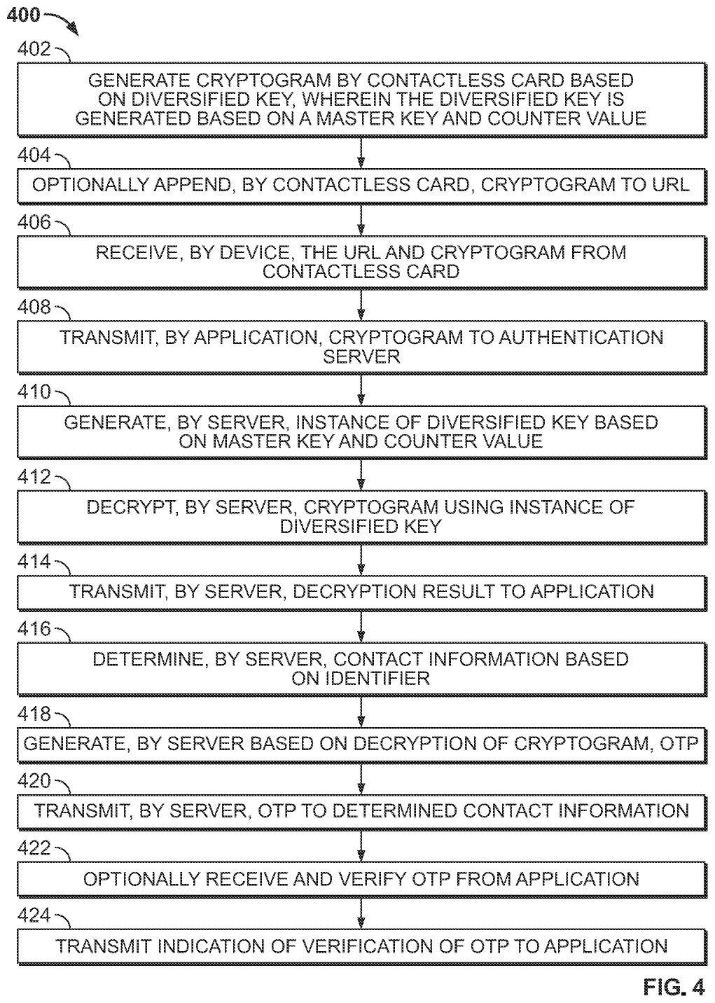

FIG. 4 illustrates an embodiment of a logic flow, or routine, 400. The routine 400 may be representative of some or all of the operations executed by one or more embodiments described herein. For example, the routine 400 may include some or all of the operations to enable secure generation of a passcode using a contactless card. Embodiments are not limited in this context. As with FIG. 3, although the passcode is specifically depicted in the routine 400 as being an OTP, such a depiction is for illustrative purposes only. Depending on the embodiment, some or all of the operations of the routine 400 can apply to generate both remedial passcodes and preemptive passcodes.

In block 402, the routine 400 receives, by an operating system 138 executing on a processor of a computing device 102, a uniform resource locator (URL) 120 and a cryptogram 134 from a contactless card 136 associated with an account. The applet 108 may generate the cryptogram 134 as described in greater detail herein. The applet 108 may further transmit an unencrypted identifier, e.g., customer ID 116 to the computing device 102. In block 404, the routine 400 launches, by the operating system 138 responsive to receiving the URL 120, an account application 118 associated with the contactless card 136. In block 406, routine 400 transmits, by the account application 118, the cryptogram 134 to an authentication server, such as the server 104 in one embodiment. The account application 118 may further transmit the unencrypted identifier to the authentication server.

In block 408, the routine 400 receives, by the account application 118, a decryption result 148 from the authentication server indicating the authentication server decrypted the cryptogram 134. In block 410, the routine 400 transmits, by the account application 118 based on the decryption result 148, a request for a passcode comprising an identifier to the URL. The identifier may be the unencrypted customer ID 116, the device identifier, and/or an identifier of the contactless card 136. In block 412, the routine 400 determines, by the server 104 based on the identifier, contact information in an account database 130. The contact information may include, but is not limited to, a phone number, email address, device identifier, etc. In block 414, the routine 400 receives, by the computing device 102 at the determined contact information, the passcode 150 from a passcode generator 142 at the URL 120. In block 416, the routine 400 receives, by the account application 118, an input value. In block 418, routine 400 compares, by the account application 118, the input value to a copy of the passcode 150 received from the passcode generator 142. In block 420, the routine 400 determines, by the application, that the comparison results in a match. In block 422, the routine 400 displays, by the account application 118 based on the determination that the comparison results in the match and based on the decryption result 148, one or more attributes of the account on the device.

FIGS. 5A-5C are sequence diagrams depicting routines 500, 530, 560 that may be representative of some or all of the operations executed according to one or more embodiments described herein. For example, the routines 500, 530, 560 may include some or all of the operations to enable verification operations based on wireless communication with a contactless card. In one embodiment, the routines 500, 530, 560 are performed by one or more of the contactless card, a computing device, and a server. In a particular embodiment, the contactless card, the computing device, and the server can be the contactless card 136, the computing device 102₁, and the server 104 of FIG. 1, respectively. Embodiments are not limited in this context, however.

In one embodiment, the routine 500 includes operations to generate a passcode based on wireless communication with a contactless card, while the routines 530, 560 represent alternative ways to apply the passcode to authorize a desired operation. In an embodiment in which card tapping is not supported for a web browser, then the operations of the computing device 102₁ can be performed by an account application in the case of FIGS. 5A-5C or a web browser in the case of FIGS. 5B-5C. If such card tapping is supported, however, then the operations of the computing device 102₁ can be performed by a web browser even in the case of FIG. 5A.

In one embodiment, the routine 500 of FIG. 5A can be performed if the user desires to generate a passcode based on communication with a contactless card. As shown, the routine 500 begins in block 502, where the computing device 102₁ submits a login request. In block 504, the server 104 approves the login request based on credentials provided with the login request. In block 506, the computing device 102₁ receives user input specifying to generate a passcode. The passcode can be a remedial passcode or a preemptive passcode. In some embodiments, in the case of a remedial passcode, the block 506 is performed only after the user after login submits a request to perform a desired operation and the server 104 prompts for a passcode to authorize the operation to be performed.

In block 508, the computing device prompts for the contactless card 136 to be tapped toward the computing device 102₁. In block 510, the contactless card 136 is tapped by the user toward the computing device 102₁. In block 512, the computing device 102₁ receives a cryptogram from the contactless card 136. In block 514, the computing device 102₁ sends the cryptogram and an unencrypted identifier to the server 104.

In block 516, the server 104 generates the passcode based on the cryptogram and associates the passcode with the unencrypted identifier. In block 518, the computing device 102₁ outputs an indication that the passcode has been generated. Depending on the embodiment, the indication can include or omit the passcode itself. If the indication omits the passcode, the user can then submit a separate request to retrieve the passcode for display on the computing device 102₁. After the block 518, the routine 500 terminates.

In one embodiment, the routine 530 of FIG. 5B can be performed if the user desires to apply the passcode to authorize a desired operation. As shown, the routine 530 begins in block 532, where the computing device 102₁ submits a login request. In block 534, the server 104 approves the login request based on credentials provided with the login request. In this regard, the credentials are accepted, by the server 104, as a first authentication factor for the user. In block 536, the computing device 102₁ receives user input specifying a desired operation pertaining to an account of the user.

In block 538, the server 104 determines whether the desired operation requires a second authentication factor for approval. This determination can be based on one or more rules applied by the server 104 to evaluate the desired operation. If the desired operation has characteristics that, under the one or more rules, do not warrant requiring a second authentication factor, the server 104 can approve the desired operation to be performed. For instance, if the desired operation is to transfer an amount (e.g., five hundred dollars) to a target account, where the amount is below a threshold (e.g., five thousand dollars), the server 104 can approve the desired operation.

On the other hand, if the desired operation has characteristics that, under the one or more rules, warrant requiring a second authentication factor, the server 104 determines whether a preemptive passcode has been generated and remains valid. If so, the computing device 102₁, in block 540 and based on communication with the server 104, additionally presents an option to view the preemptive passcode. Otherwise, the computing device 102₁ in block 540 only prompts for user input specifying a passcode such as a remedial passcode or a preemptive passcode.

In block 542, the computing device 102₁ optionally requests, based on user input, to retrieve the stored passcode from the server 104. In block 544, the server receives the request, retrieves the stored passcode, and sends the passcode to the computing device 102₁. The computing device 102₁ receives and outputs the passcode for display to the user.

In some embodiments, the passcode is received via SMS and output via a messaging application separate from the account application. In an alternative embodiment, however, the passcode is received by the account application using a same protocol for communicating with the server, e.g., Hypertext Transfer Protocol Secure (HTTPS), rather than via a messaging application over SMS. In such an embodiment, the passcode is output, for display to the user, via the account application rather than via a messaging application.

Regardless of whether the operations in blocks 542 and 544 are performed, in block 546, the computing device 102₁ receives user input specifying a passcode. For instance, the passcode can be specified by the user via an input device such as a microphone, a touchscreen, a touchpad, a keyboard, a pointing device, and so forth. In one embodiment, the passcode can be provided by the user based on user viewing of the stored passcode as a result of the blocks 542 and 544 being performed. Alternatively, the passcode can be provided by the user based on user recollection from a previous viewing of the stored passcode. The computing device 102₁ sends the specified passcode to the server 104.

In block 548, the server 104 determines whether the specified passcode matches a stored passcode such as a remedial passcode or a preemptive passcode. In the case of the preemptive passcode, if the server 104 determines that a match is present, the server 104 accepts the specified passcode as a second authentication factor for the user and approves the desired operation to be performed; the desired operation is then performed. In this regard, the desired operation is approved without requiring the contactless card 136 to be re-tapped by the user toward the computing device 102₁. That the contactless card 136 is not required to be re-tapped is represented in the form of block 552.

More specifically, the contactless card 136 is not required to be tapped during or after a time that the desired operation is specified based on user input (in block 536). Put another way, a prior tapping of the contactless card 136, when performed as part of a user request to generate a preemptive passcode, is permitted to be carried forward in time to apply to one or more desired operations. Advantageously, the one or more desired operations can be authorized even the user is not currently in possession of the contactless card and/or is not currently with a mobile carrier network capable of receiving the passcode from the server 104 or an computer associated therewith.

On the other hand, in the case of the remedial passcode in block 548, if the server 104 determines that a match is present, the server 104 accepts the specified passcode as a second authentication factor for the user and approves the desired operation to be performed; the desired operation is then performed. Unlike for the preemptive passcode, however, use of the remedial passcode in block 548 at least in some embodiments necessitates tapping of the contactless card by the user in or after the block 536, to generate the remedial passcode to then to be provided in block 540. The tapping of the contactless card being necessitated forecloses from the user the option of generating and using the remedial passcode to authorize a desired operation, if the user is not currently in possession of the contactless card and/or is not currently with a mobile carrier network capable of receiving the passcode from the server 104 or an computer associated therewith.

Accordingly, the alternative of using the preemptive passcode, provided that one was generated in advance by request of the user, can permit desired operations to be authorized and performed, in use cases where the desired operations simply cannot be authorized absent a favorable change in conditions pertaining to the use case of the user. Put another way, the desired operations can be in a make-or-break scenario contingent on whether preemptive passcodes are supported by the computing environment that is at least in part provided by the institution of which the user is a customer.

Examples of favorable changes include the user becoming in possession of the contactless card or of a new or replacement contactless card, the user being in possession of a computing device operatively connected to a mobile carrier network capable of receiving the passcode from the server 104 or an associated compute therewith, and the like. If the user has been traveling, as a practical matter, the user may need to return from traveling for the favorable changes to come about. This can be the case especially when policies of the institution prevent any physical mailing of a new or replacement contactless card to any temporary mailing address. Additionally or alternatively, the policies may permit physical mailing to a new permanent address only after a specified time delay for security purposes (e.g., a wait time of thirty days).

As an alternative to the routine 530 of FIG. 5B, the routine 560 of FIG. 5C can be performed if the user desires to apply the passcode to authorize a desired operation. Unlike the routine 530, in which the passcode is specified by the user without a service agent, the routine 560 includes the user specifying the passcode to a service agent such as a call-center agent. The routine 560 can be of use to the user especially in use cases where the user is not currently in possession of a computing device capable of running the account application or is desiring agent assistance with specified features of the account application.

In this regard, the passcode can be specified to the call-center agent by the user orally reciting the passcode to the call-center agent during an audio call between the user and the call-center agent. The call-center agent listens to the passcode being orally recited and enters the passcode into an application executing on a computing device 102₂ of the call-center agent. Depending on the embodiment, the application can be a customer-service application that is a standalone application operatively connected to the server, or alternatively, the application can be a customer-service interface to the server. Further, the application can be a native application or, alternatively, a web browser operatively connected to a web application included in or operatively connected to the server.

Once the passcode is entered, the application and/or the server can determine whether the passcode is acceptable for authorizing the desired operation. If so, the application outputs an indication to the call-center agent that the desired operation is approved, and the call-center agent can orally relay the approval to the user via the audio call. Otherwise, the application outputs an indication to the call-center agent that the passcode is invalid and/or that the desired operation is denied, and the call-center agent can relay the same to the user via the audio call.

As shown, the routine 560 begins in block 562, where the computing device 102₂ sends, to the server 104, a request for customer information based on input, by the call-center agent, of information provided by the user during the audio call. The information can include customer and/or account information associated with the user. In block 564, the server 104 identifies an account belonging to the user and/or stored additional information associated with the account and/or the user. The server 104 sends an indicator of the account and/or the additional information to the computing device 102₂ to output to the call-center agent.

The call-center agent then asks the user to orally recite, via the audio call, additional information as a first authentication factor for the user. In block 568, the call-center agent manually verifies, or inputs for the computing device 102₂ and/or the server to automatically verify, that the recited additional information matches the stored additional information. If a match is determined as being present, the call-center agent can ask the user to orally recite, via the audio call, a desired operation that the user is requesting to be performed. Upon listening to the oral recitation of the desired operation by the user, the call-center agent can provide input specifying the desired operation to the computing device 102₂. The computing device 102₂ then sends the input to the server 104.

In block 570, the server 104 determines, based on the input, whether the desired operation has characteristics that, based on the rules, warrant requiring the user to provide, to the call-center agent, a second authentication factor for the user. If the second authentication factor is not warranted, the server 104 approves the operation to be performed, and the server 104 can send an indication of the approval to the computing device 102₂ for output to the call-center agent to orally relay to the user via the audio call.

Otherwise, the call-center agent orally requests the user to provide a passcode as a second authentication factor to authorize the desired operation to be performed. After the user orally recites the passcode to the call-center via the audio call, in one embodiment, the computing device 102₂ in block 572 receives, from the call-center agent, input specifying the passcode recited by the user. The computing device 102₂ then sends the recited passcode to the server 104 to determine, in block 578, whether the recited passcode is acceptable as the second authentication factor.

If the recited passcode is determined as being acceptable as the second authentication factor, the transaction is approved to be performed. In the case of the recited passcode being a preemptive passcode, the transaction is approved without requiring the contactless card 136 to be re-tapped, by the user, toward the computing device 102₁. In particular, the contactless card 136 is not required to be tapped by the user at or after a time at which the user orally recites a desired transaction to the call-center agent for input in the block 568. The contactless card 136 not being required to be re-tapped is represented in the form of block 580.

On the other hand, in the case of the recited passcode being a remedial passcode, the contactless card 136 is required to be tapped, by the user, toward the computing device 102₂ at or after the time at which the user orally recites the desired transaction to the call-center agent for input in the block 568. This means that in the absence of a preemptive passcode, the operation cannot be approved or performed if the user does not currently have possession of the contactless card 136 and/or if the computing device 102₁ is not in possession by the user and/or is currently connected to a carrier network incapable of communications with the server and its associated systems.

In an alternative embodiment, the computing device 102₂ in block 572 receives, from the server 104, one or more stored passcodes recognized by the server 104 as being valid. The one or more stored passcodes are output, via the computing device 102₂, for display to the call-center agent, who can then manually verify whether the recited passcode matches one of the one or more stored passcodes. The call-center agent can then provide, to the computing device 102₂ to send to the server 104, input indicating whether the call-center agent manually found a match or manually determined that no match exists. The server 104 in block 578 can then approve or deny the operation based on the input, and the call-center agent can orally convey the approval or denial to the user via the audio call.

FIG. 6 illustrates an embodiment of a logic flow, or routine, 600. The routine 600 may be representative of some or all of the operations executed according to one or more embodiments described herein. For example, the routine 600 may include some or all of the operations to enable verification operations based on wireless communication with a contactless card. In one embodiment, the routine 600 is performed by a server, e.g., the server 104 of FIG. 1. Embodiments are not limited in this context.

As shown, the routine begins in block 610, where the server stores a passcode generated based on a cryptogram read from a contactless card. The passcode is generated responsive to a device detecting the contactless card. Further, the passcode has an associated account and an associated validity criterion.

In block 620, the server receives one or more requests, each request specifying to perform a respective operation associated with the account. Each request further specifies a respective passcode. Each passcode can be a remedial passcode or a preemptive passcode. The remedial passcode is generated subsequent to the operation being specified, based on user input, as being desired to be performed. In contrast, the preemptive passcode is generated prior to the operation being specified, based on user input, as being desired to be performed.

In block 630, the server enters a loop to process each of the one or more requests, such as to determine whether to authorize the operation based on the remedial passcode or the preemptive passcode. In block 640, the server determines whether the passcode specified by the request matches the stored passcode.

For instance, the server determines whether the remedial passcode specified by the request matches a stored remedial passcode. Alternatively, the server determines whether the preemptive passcode specified by the request matches a stored preemptive passcode. In some embodiments, a passcode match is only accepted if the passcode types also match. In such embodiments, a remedial passcode and a preemptive passcode are not deemed as being a match even if the associated passcode values are identical. In an alternative embodiment, however, the passcode types need not match if the passcode values are identical.

If the server in block 640 determines that a match is found, the routine 600 proceeds to block 650, where the server determines whether the one or more validity criteria of the stored passcode remain satisfied. For instance, the server can determine whether an associated validity period, if any, has elapsed and/or whether an associated maximum number of uses, if any, has been reached.

If the server in block 650 determines that the one or more validity criteria remain satisfied, the routine 600 proceeds to block 660, where the server authorizes the operation of the request to be performed. In the case of the passcode being a preemptive passcode, the operation is authorized without requiring the computing device of the user to detect the contactless card at or after a time of the operation being specified by the user as being desired to be performed.

In some embodiments, the operation can be independently authorized based on any of multiple passcodes, including a remedial passcode and a preemptive passcode. In other words, it may not necessarily be the case that only a single passcode is acceptable by the server as being a valid passcode that permits the operation to be authorized to be performed. In an alternative embodiment, however, only a single passcode is acceptable by the server as being a valid passcode. In such an embodiment, each passcode, whether remedial or preemptive, is subject to automatic deactivation upon a new passcode, whether remedial or preemptive, being generated.

After the block 660, or if the determination in block 640 or 650 is in the negative, the routine 600 proceeds to block 670, where the server denies authorizing the operation. As a result, the operation is not performed. After the block 660 or 670, the routine 600 proceeds to block 680, where the server determines if any request remains to be processed as part of the loop. If so, the routine 600 returns to the block 630 to process a remaining request. Otherwise, the routine 600 terminates.

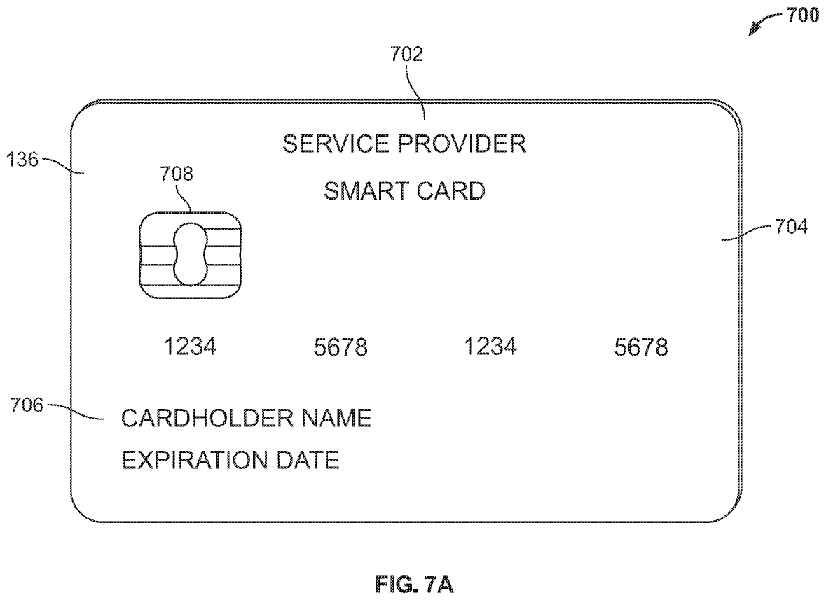

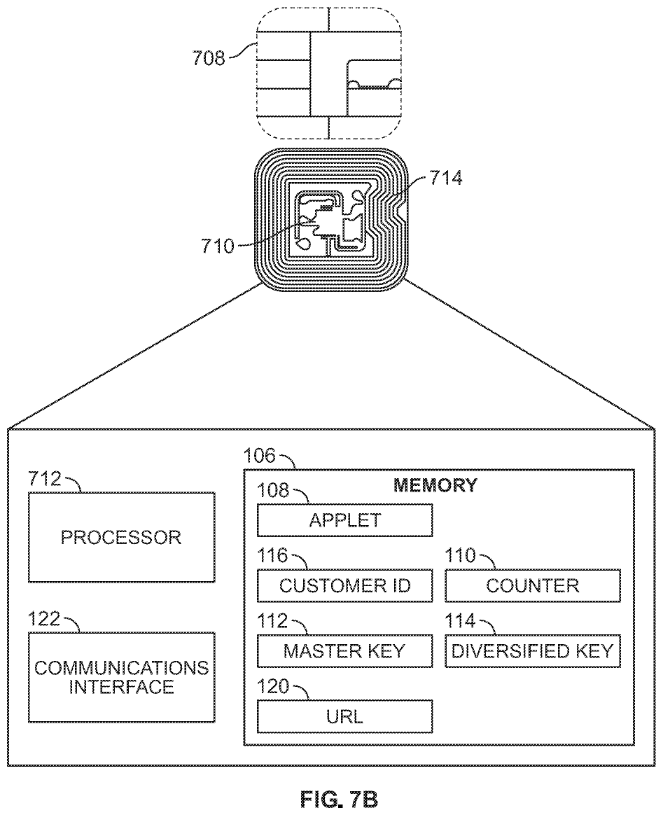

FIG. 7A is a schematic 700 illustrating an example configuration of a contactless card 136, which may include a payment card, such as a credit card, debit card, or gift card, issued by a service provider as displayed as service provider indicia 702 on the front or back of the contactless card 136. In some examples, the contactless card 136 is not related to a payment card, and may include, without limitation, an identification card. In some examples, the transaction card may include a dual interface contactless payment card, a rewards card, and so forth. The contactless card 136 may include a substrate 704, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 136 may have physical characteristics compliant with the ID-1 format of the ISO/IEC 7816 standard, and the transaction card may otherwise be compliant with the ISO/IEC 14443 standard. However, it is understood that the contactless card 136 according to the present disclosure may have different characteristics, and the present disclosure does not require a transaction card to be implemented in a payment card.

The contactless card 136 may also include identification information 706 displayed on the front and/or back of the card, and a contact pad 708. The contact pad 708 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 136 may also include processing circuitry, antenna and other components as will be further discussed in FIG. 7B. These components may be located behind the contact pad 708 or elsewhere on the substrate 704, e.g. within a different layer of the substrate 704, and may electrically and physically coupled with the contact pad 708. The contactless card 136 may also include a magnetic strip or tape, which may be located on the back of the card (not shown in FIG. 7A). The contactless card 136 may also include an NFC device coupled with an antenna capable of communicating via the NFC protocol. Embodiments are not limited in this manner.

As illustrated in FIG. 1A, the contact pad 708 of contactless card 136 may include processing circuitry 710 for storing, processing, and communicating information, including a processor 712, a memory 106, and one or more communications interface 122. It is understood that the processing circuitry 710 may contain additional components, including processors, memories, error and parity/CRC checkers, data encoders, anticollision algorithms, controllers, command decoders, security primitives and tamperproofing hardware, as necessary to perform the functions described herein.

The memory 106 may be a read-only memory, write-once read-multiple memory or read/write memory, e.g., RAM, ROM, and EEPROM, and the contactless card 136 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 106 may be encrypted memory utilizing an encryption algorithm executed by the processor 712 to encrypted data.

The memory 106 may be configured to store one or more applets 108, one or more counters 110, a customer ID 116, the master key 112, diversified key 114, and URLs 120. The one or more applets 108 may comprise one or more software applications configured to execute on one or more contactless cards, such as a Java® Card applet. However, it is understood that applet 108 are not limited to Java Card applets, and instead may be any software application operable on contactless cards or other devices having limited memory. The one or more counter 110 may comprise a numeric counter sufficient to store an integer. The customer ID 116 may comprise a unique alphanumeric identifier assigned to a user of the contactless card 136, and the identifier may distinguish the user of the contactless card from other contactless card users. In some examples, the customer ID 116 may identify both a customer and an account assigned to that customer and may further identify the contactless card 136 associated with the customer's account.

Referring now to FIG. 7B, the processor 712 and memory elements of the foregoing exemplary embodiments are described with reference to the contact pad 708, but the present disclosure is not limited thereto. It is understood that these elements may be implemented outside of the contact pad 708 or entirely separate from it, or as further elements in addition to processor 712 and memory 106 elements located within the contact pad 708.

In some examples, the contactless card 136 may comprise one or more antenna(s) 714. The one or more antenna(s) 714 may be placed within the contactless card 136 and around the processing circuitry 710 of the contact pad 708. For example, the one or more antenna(s) 714 may be integral with the processing circuitry 710 and the one or more antenna(s) 714 may be used with an external booster coil. As another example, the one or more antenna(s) 714 may be external to the contact pad 708 and the processing circuitry 710.

In an embodiment, the coil of contactless card 136 may act as the secondary of an air core transformer. The terminal may communicate with the contactless card 136 by cutting power or amplitude modulation. The contactless card 136 may infer the data transmitted from the terminal using the gaps in the power connection of the contactless card 136, which may be functionally maintained through one or more capacitors. The contactless card 136 may communicate back by switching a load on the coil of the contactless card 136 or load modulation. Load modulation may be detected in the terminal's coil through interference. More generally, using the antenna(s) 714, processor 712, and/or the memory 106, the contactless card 136 provides a communications interface to communicate via NFC, Bluetooth, and/or Wi-Fi communications.

As explained above, contactless card 136 may be built on a software platform operable on smart cards or other devices having limited memory, such as JavaCard, and one or more or more applications or applets may be securely executed. Applet 108 may be added to contactless cards to provide a passcode for multifactor authentication (MFA) in various mobile application-based use cases. Applet 108 may be configured to respond to one or more requests, such as near field data exchange requests, from a reader, such as a mobile NFC reader (e.g., of a mobile computing device 102 or point-of-sale terminal), and produce an NDEF message that comprises a cryptographically secure passcode encoded as an NDEF text tag. The NDEF message may include the URL 120, the cryptogram 134, and any other data.

One example of an NDEF passcode is an NDEF short-record layout (SR=1). In such an example, one or more applets 108 may be configured to encode the passcode as an NDEF type 4 well known type text tag. In some examples, NDEF messages may comprise one or more records. The applet 108 may be configured to add one or more static tag records in addition to the passcode record.

In some examples, the one or more applets 108 may be configured to emulate an RFID tag. The RFID tag may include one or more polymorphic tags. In some examples, each time the tag is read, different cryptographic data is presented that may indicate the authenticity of the contactless card. Based on the one or more applets 108, an NFC read of the tag may be processed, the data may be transmitted to a server, such as a server of the institution, e.g., a banking system, and the data may be validated at the server.

In some examples, the contactless card 136 and server may include certain data such that the card may be properly identified. The contactless card 136 may include one or more unique identifiers (not pictured). Each time a read operation takes place, the counter 110 may be configured to increment. In some examples, each time data from the contactless card 136 is read (e.g., by a mobile device), the counter 110 is transmitted to the server for validation and determines whether the counter 110 are equal (as part of the validation) to a counter of the server.

The one or more counter 110 may be configured to prevent a replay attack. For example, if a cryptogram has been obtained and replayed, that cryptogram is immediately rejected if the counter 110 has been read or used or otherwise passed over. If the counter 110 has not been used, it may be replayed. In some examples, the counter that is incremented on the contactless card 136 is different from the counter that is incremented for transactions. The contactless card 136 is unable to determine the application transaction counter 110 since there is no communication between applets 108 on the contactless card 136. In some examples, the contactless card 136 may comprise a first applet 440-1, which may be a transaction applet, and a second applet 440-2. Each applet 440-1 and 440-2 may comprise a respective counter 110.

In some examples, the counter 110 may get out of sync. In some examples, to account for accidental reads that initiate transactions, such as reading at an angle, the counter 110 may increment but the application does not process the counter 110. In some examples, when the mobile device 10 is woken up, NFC may be enabled and the device 102 may be configured to read available tags, but no action is taken responsive to the reads.

To keep the counter 110 in sync, an application, such as a background application, may be executed that would be configured to detect when the mobile device 102 wakes up and synchronize with the server of a banking system indicating that a read that occurred due to detection to then move the counter 110 forward. In other examples, Hashed One Time Password may be utilized such that a window of mis-synchronization may be accepted. For example, if within a threshold of 10, the counter 110 may be configured to move forward. But if within a different threshold number, for example within 10 or 1000, a request for performing re-synchronization may be processed which requests via one or more applications that the user tap, gesture, or otherwise indicate one or more times via the user's device. If the counter 110 increases in the appropriate sequence, then it possible to know that the user has done so.

The key diversification technique described herein with reference to the counter 110, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 136, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 136. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 136 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

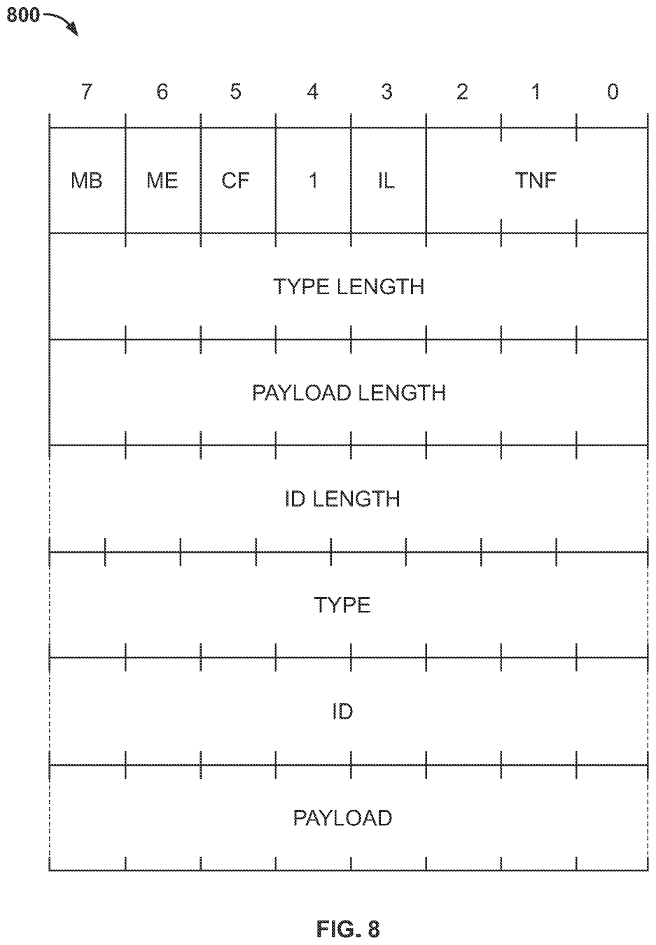

FIG. 8 illustrates an NDEF short-record layout (SR=1) data structure 800 according to an example embodiment. One or more applets may be configured to encode the passcode as an NDEF type 4 well known type text tag. In some examples, NDEF messages may comprise one or more records. The applets may be configured to add one or more static tag records in addition to the passcode record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data. The data structure 800 may include the URL 120, the cryptogram 134, and any other data provided by the applet 108.

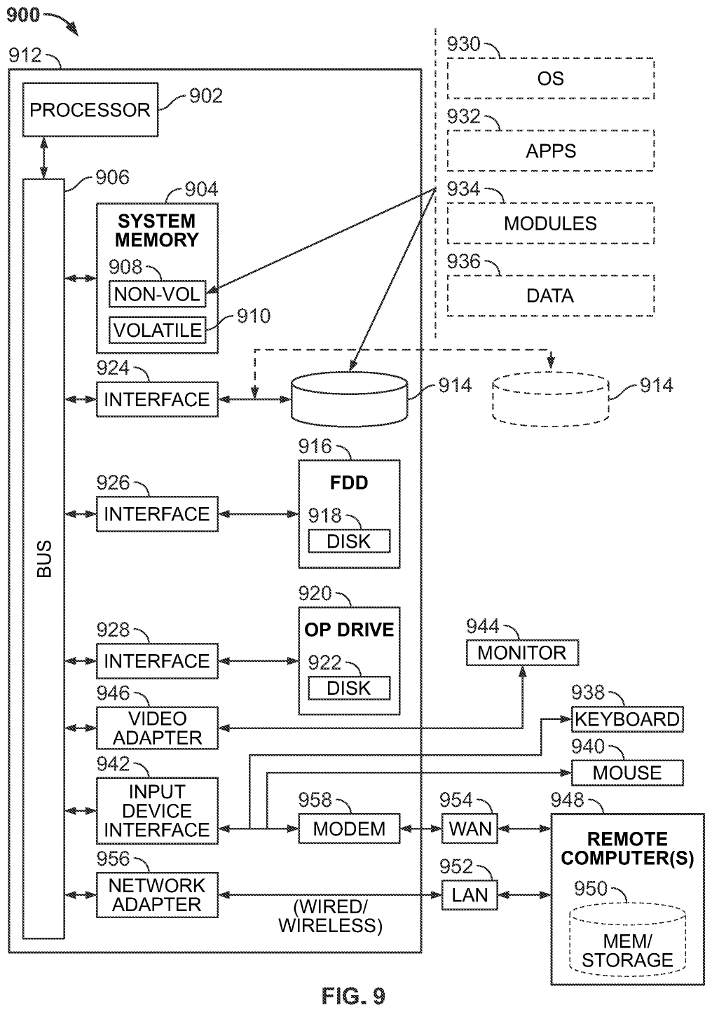

FIG. 9 illustrates an embodiment of an exemplary computer architecture 900 suitable for implementing various embodiments as previously described. In one embodiment, the computer architecture 900 may include or be implemented as part of computing architecture 100.

As used in this application, the terms “system” and “component” are intended to refer to a computer-related entity, either hardware, a combination of hardware and software, software, or software in execution, examples of which are provided by the exemplary computing computer architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 9, the computer architecture 900 includes a processor 902, a system memory 904 and a system bus 906. The processor 902 can be any of various commercially available processors.

The system bus 906 provides an interface for system components including, but not limited to, the system memory 904 to the processor 902. The system bus 906 can be any of several types of bus structure that may further interconnect to a memory bus (with or without a memory controller), a peripheral bus, and a local bus using any of a variety of commercially available bus architectures. Interface adapters may connect to the system bus 906 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 900 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 904 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 904 can include non-volatile 908 and/or volatile 910. A basic input/output system (BIOS) can be stored in the non-volatile 908.

The computer 912 may include various types of computer-readable storage media in the form of one or more lower speed memory units, including an internal (or external) hard disk drive 914, a magnetic disk drive 916 to read from or write to a removable magnetic disk 918, and an optical disk drive 920 to read from or write to a removable optical disk 922 (e.g., a CD-ROM or DVD). The hard disk drive 914, magnetic disk drive 916 and optical disk drive 920 can be connected to system bus 906 the by an HDD interface 924, and FDD interface 926 and an optical disk drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 908, and volatile 910, including an operating system 930, one or more applications 932, other program modules 934, and program data 936. In one embodiment, the one or more applications 932, other program modules 934, and program data 936 can include, for example, the various applications and/or components of the system 100.

A user can enter commands and information into the computer 912 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 902 through an input device interface 942 that is coupled to the system bus 906 but can be connected by other interfaces such as a parallel port, IEEE 1394 serial port, a game port, a USB port, an IR interface, and so forth.

A monitor 944 or other type of display device is also connected to the system bus 906 via an interface, such as a video adapter 946. The monitor 944 may be internal or external to the computer 912. In addition to the monitor 944, a computer typically includes other peripheral output devices, such as speakers, printers, and so forth.

The computer 912 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all the elements described relative to the computer 912, although, for purposes of brevity, only a memory and/or storage device 950 is illustrated. The logical connections depicted include wire/wireless connectivity to a local area network 952 and/or larger networks, for example, a wide area network 954. Such LAN and WAN networking environments are commonplace in offices and companies, and facilitate enterprise-wide computer networks, such as intranets, all of which may connect to a global communications network, for example, the Internet.

When used in a local area network 952 networking environment, the computer 912 is connected to the local area network 952 through a wire and/or wireless communication network interface or network adapter 956. The network adapter 956 can facilitate wire and/or wireless communications to the local area network 952, which may also include a wireless access point disposed thereon for communicating with the wireless functionality of the network adapter 956.

When used in a wide area network 954 networking environment, the computer 912 can include a modem 958, or is connected to a communications server on the wide area network 954 or has other means for establishing communications over the wide area network 954, such as by way of the Internet. The modem 958, which can be internal or external and a wire and/or wireless device, connects to the system bus 906 via the input device interface 942. In a networked environment, program modules depicted relative to the computer 912, or portions thereof, can be stored in the remote memory and/or storage device 950. It will be appreciated that the network connections shown are exemplary and other means of establishing a communications link between the computers can be used.

The computer 912 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1A-9 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A method, comprising:
storing, by a server, a passcode that is generated based on a cryptogram read from a contactless card, wherein the passcode is generated responsive to a device detecting the contactless card, and wherein the passcode is associated with an account and a validity criterion;
receiving one or more requests, each request specifying to perform a respective operation associated with the account, each request further specifying a respective passcode generated prior to the respective operation being specified; and
upon determining that the passcode specified by a first request of the one or more requests matches the passcode stored by the server and that the validity criterion remains satisfied, authorizing the operation specified by the first request to be performed, wherein the operation is authorized without requiring the device to redetect the contactless card.

2. The method of claim 1, wherein the validity criterion comprises a validity period of time.

3. The method of claim 1, wherein the operation specified by the first request is further authorized based on verifying authentication credentials for the account.

4. The method of claim 2, wherein the passcode is generated responsive to a request to preemptively generate the passcode for the validity period, wherein the passcode is not otherwise generated responsive to any requested operation associated with the account, and wherein responsive to the request to preemptively generate the passcode.

5. The method of claim 2, further comprising:
upon determining that the passcode specified by a second request of the one or more requests does not match the passcode stored by the server and that the validity period has not elapsed, requiring (i) a matching passcode to be provided or (ii) the device to redetect the contactless card, before authorizing the operation specified by the second request to be performed.

6. The method of claim 2, further comprising:
upon determining that the passcode specified by a third request of the one or more requests matches the passcode stored by the server and that the validity period has elapsed, requiring the device to redetect the contactless card before authorizing the operation specified by the third request to be performed.

7. The method of claim 2, further comprising:
upon determining that the passcode specified by a fourth request of the one or more requests does not match the passcode stored by the server and that the validity period has elapsed, requiring the device to redetect the contactless card before authorizing the operation specified by the fourth request to be performed.

8. The method of claim 1, wherein the passcode specified by the first request is provided based on input received via an input device selected from a microphone, a touchscreen, a touchpad, a keyboard, and a pointing device.

9. The method of claim 8, wherein the passcode specified by the first request is provided via at least one of a call-center agent or a web browser application.

10. The method of claim 8, further comprising:
receiving a request to retrieve the passcode stored by the server; and
sending the passcode stored by the server to an application on the device, wherein the application outputs the passcode, wherein the passcode specified by the first request is provided based on the outputted passcode.

11. The method of claim 8, wherein the input device is operatively connected to (i) a first device comprising the device or (ii) a second device other than the device.

12. The method of claim 1, wherein the one or more requests comprise a plurality of requests, and wherein the respective operation of each of the plurality of requests is authorized based on a same passcode stored by the server.

13. The method of claim 1, wherein the cryptogram and a uniform resource locator (URL) are readable from the contactless card based on near field communication (NFC).

14. The method of claim 13, wherein the server comprises an authentication server configured to:
receive the cryptogram from the device;
transmit, to the device, a decryption result indicating that the authentication server has decrypted the cryptogram;
receive, from the device, a request for the passcode, the request comprising an identifier based on at least one of a customer identifier, an account identifier, a device identifier, or a card identifier;
generate the passcode using a component of the authentication server, the component comprising a password generator that is accessible via the URL; and
transmit the passcode to the device.

15. A non-transitory computer-readable medium, the non-transitory computer-readable medium including instructions that when executed by a processor, cause the processor to:
store a passcode that is generated based on a cryptogram read from a contactless card, wherein the passcode is generated responsive to a device detecting the contactless card, and wherein the passcode is associated with an account and a validity criterion;
receive one or more requests, each request specifying to perform a respective operation associated with the account, each request further specifying a respective passcode generated prior to the respective operation being specified; and
upon determining that the passcode specified by a first request of the one or more requests matches the passcode stored and that the validity criterion remains satisfied, authorize the operation specified by the first request to be performed, wherein the operation is authorized without requiring the device to redetect the contactless card.

16. The non-transitory computer-readable medium of claim 15, wherein the validity criterion comprises a validity period of time.

17. The non-transitory computer-readable medium of claim 15, wherein the operation specified by the first request is further authorized based on verifying authentication credentials for the account.

18. A system, comprising:
a processor; and
a memory storing instructions executable by the processor to cause the processor to:
store a passcode that is generated based on a cryptogram read from a contactless card, wherein the passcode is generated responsive to a device detecting the contactless card, and wherein the passcode is associated with an account and a validity criterion;
receive one or more requests, each request specifying to perform a respective operation associated with the account, each request further specifying a respective passcode generated prior to the respective operation being specified; and
upon determining that the passcode specified by a first request of the one or more requests matches the passcode stored and that the validity criterion remains satisfied, authorize the operation specified by the first request to be performed, wherein the operation is authorized without requiring the device to redetect the contactless card.

19. The system of claim 18, wherein the validity criterion comprises a validity period of time.

20. The system of claim 18, wherein the operation specified by the first request is further authorized based on verifying authentication credentials for the account.
